(19) United States
(12) Patent Application Publication
(10) Pub. No.: US 2020/0379724 A1
(43) Pub. Date: Dec. 3, 2020

(54) MOBILE TERMINAL AND CONTROL METHOD THEREFOR

(71) Applicant: LG ELECTRONICS INC., Seoul (KR)

(72) Inventors: Namki KIM, Seoul (KR); Jiwon KANG, Seoul (KR); Joongyeon KIM, Seoul (KR); Yoonseok YANG, Seoul (KR); Suhjin YI, Seoul (KR)

(73) Assignee: LG ELECTRONICS INC., Seoul (KR)

(21) Appl. No.: 16/326,591

(22) PCT Filed: Apr. 12, 2017
(86) PCT No.: PCT/KR2017/003952

§ 371 Date: Feb. 19, 2019

(30) Foreign Application Priority Data
Aug. 19, 2016 (KR) 10-2016-0105443

(51) Int. Cl. G06F 3/16; G06F 3/0481; H04M 1/725

(52) U.S. Cl. CPC G06F 3/167; H04M 1/72583; G06F 3/165; G06F 3/04817

(57) ABSTRACT

The present invention relates to: a mobile terminal capable of setting a plurality of parameter values determining sound quality, according to a situation in which audio is recorded when an audio recording function is executed; and a control method therefor. According to one aspect of the present invention for achieving the aforementioned purpose or another purpose, provided is a mobile terminal comprising a display unit, a voice recognition unit, and a controller, wherein, when the audio recording function is activated, the controller senses a sound through the voice recognition unit, outputs, on the display unit, a popup of a recommended audio preset determined on the basis of the sensed sound from among a plurality of audio presets, and sets the recommended audio preset to the audio recording function according to a control command of selecting the recommended audio preset popup.

### TECHNICAL FIELD

The present invention relates to a mobile terminal and control method thereof, suitable for providing an audio preset capable of setting a plurality of parameter values for determining a sound quality depending on an audio recording performed situation in case of executing an audio recording function.

### BACKGROUND ART

Terminals can be classified into mobile/portable terminals and stationary terminals. In particular, the mobile terminals can be further classified into handheld terminals and vehicle mounted terminals according to possibility of user's direct portability.

Recently, functions of a mobile terminal tend to be diversified. For instance, the diversified functions include a function of data and audio communication, a function of photographing and video-making through a camera, a function of audio recording, a function of music file play through a speaker system, a function of outputting an image or video to a display unit, and the like. A prescribed terminal is further equipped with an electronic game play function or performs a multimedia player function. Particularly, a recent mobile terminal is able to receive multicast signals for providing visual contents such as a broadcast, a video, a television program and the like.

As functions of the terminal are getting diversified, the terminal tends to be implemented as a multimedia player provided with complex functions such as photographing of photos or videos, playback of music or video files, game play, broadcast reception and the like for example.

To support and increase the terminal functions, it may be able to consider improving structural parts and/or software parts of the terminal.

Meanwhile, in case of performing an audio recording using a mobile terminal, a sound quality of a recorded audio file may not be good in comparison with a case of using a professional audio recording equipment. To resolve such an issue, it is necessary to provide various audio presets for enabling an audio recording of high quality depending on a situation in a mobile terminal.

### DISCLOSURE OF THE INVENTION

### Technical Task

The present invention is intended to solve the above problem and other problems. One technical task of one embodiment of the present invention is to provide a mobile terminal and control method thereof, which can provide an audio preset suitable for a situation that an audio recording is performed in the mobile terminal.

Another technical task of one embodiment of the present invention is to provide a mobile terminal and control method thereof, by which an audio preset provided in an audio recording can be identically provided to a video recording.

### Technical Solutions

In one technical aspect of the present invention, provided herein is a mobile terminal, including a display unit, a voice recognition unit, and a controller configured to if an audio recording function is activated, sense a sound through the voice recognition unit, output a popup of a recommended audio preset determined on the basis of the sensed sound among a plurality of audio presets to the display unit, and set the recommended audio preset for the audio recording function in response to a control command for selecting the recommended audio preset popup.

In another technical aspect of the present invention, provided herein is a method of controlling a mobile terminal, the method including if an audio recording function is activated, sensing a sound through a microphone, outputting a popup of a recommended audio preset determined on the basis of the sensed sound among a plurality of audio presets to a display unit, and setting the recommended audio preset for the audio recording function in response to a control command for selecting the recommended audio preset popup.

### Advantageous Effects

Effects of a mobile terminal and control method thereof according to the present invention are described as follows.

According to at least one of embodiments of the present invention, it is advantageous in that a mobile terminal can provide a high-quality recording of a professional equipment level through an audio recording application.

According to at least one of embodiments of the present invention, it is advantageous in that a mobile terminal can provide an audio preset suitable for a situation based on a sound sensed through a plurality of microphones.

According to at least one of embodiments of the present invention, it is advantageous in that a mobile terminal can provide a high-quality audio recording in the course of a video recording, as well as an audio recording application.

Further scope of applicability of the present invention will become apparent from the detailed description given hereinafter. However, it should be understood that the detailed description and specific examples, while indicating preferred embodiments of the invention, are given by illustration only, since various changes and modifications within the spirit and scope of the invention will become apparent to those skilled in the art from this detailed description.

### DESCRIPTION OF DRAWINGS

FIG. 1A is a block diagram to describe a mobile terminal related to the present disclosure.

FIG. 1B and FIG. 1C are conceptual diagrams for one example of a mobile terminal related to the present invention, viewed from different directions.

FIG. 2 is a conceptual diagram to describe another example of a deformable mobile terminal 200 according to the present disclosure.

FIG. 3 is a perspective diagram for one example of a watch type mobile terminal 300 related to another embodiment of the present invention.

FIG. 4 is a perspective diagram for one example of a glass type mobile terminal 400 related to further embodiment of the present invention.

FIG. 5 is a block diagram showing configuration modules of a mobile terminal according to one embodiment of the present invention.

FIG. 6 is a diagram showing one example of a plurality of microphones provided to a mobile terminal according to one embodiment of the present invention.

FIG. 7 is a diagram showing one example of a running screen of an audio recording application of a mobile terminal according to one embodiment of the present invention.

FIG. 8 is a diagram showing one example of a plurality of audio presets provided in a mobile terminal according to one embodiment of the present invention.

FIG. 9 is a diagram showing one example of utilizing a first display region of a mobile terminal according, to one embodiment of the present invention.

FIG. 10 is a diagram showing one example of utilizing a first display region of a mobile terminal according to one embodiment of the present invention.

FIG. 11 is a diagram showing one example of recognizing a recording situation in a mobile terminal according to one embodiment of the present invention.

FIG. 12 is a diagram showing another example of recognizing a recording situation in a mobile terminal according to one embodiment of the present invention.

FIG. 13 is a diagram showing another example of recognizing a recording situation in a mobile terminal according to one embodiment of the present invention.

FIG. 14 is a diagram showing another example of recognizing a recording situation in a mobile terminal according to one embodiment of the present invention.

FIG. 15 is a diagram showing another example of recognizing a recording situation in a mobile terminal according to one embodiment of the present invention.

FIG. 16 is a diagram showing one example of recognizing a recording situation through additional information as well as sound information sensed through a microphone in a mobile terminal according to one embodiment of the present invention.

FIG. 17 is a diagram showing one example of providing an audio preset and an additional control preset in case of launching an audio recording application in a mobile terminal according to one embodiment of the present invention.

FIG. 18 is a diagram showing another example of providing an audio preset and an additional control preset in case of launching an audio recording application in a mobile terminal according to one embodiment of the present invention.

FIG. 19 is a diagram showing another example of providing an audio preset and an additional control preset in case of launching an audio recording application in a mobile terminal according to one embodiment of the present invention.

FIG. 20 is a diagram showing another example of providing an audio preset and an additional control preset in case of launching an audio recording application in a mobile terminal according to one embodiment of the present invention.

FIG. 21 is a diagram showing one example of performing a temporary recording automatically before starting an audio recording in a mobile terminal according to one embodiment of the present invention.

FIG. 22 is a diagram showing one example of performing a temporary recording automatically before starting an audio recording in a mobile terminal according to one embodiment of the present invention.

FIG. 23 is a diagram showing one example of providing an audio preset in the course of a video shooting in a mobile terminal according to one embodiment of the present invention.

FIG. 24 is a diagram showing another example of providing an audio preset in the course of a video shooting in a mobile terminal according to one embodiment of the present invention.

FIG. 25 is a diagram showing another example of providing an audio preset in the course of a video shooting in a mobile terminal according to one embodiment of the present invention.

FIG. 26 is a diagram showing another example of providing an audio preset in the course of a video shooting in a mobile terminal according to one embodiment of the present invention.

FIG. 27 is a flowchart showing a method of controlling a mobile terminal according to one embodiment of the present invention.

### BEST MODE FOR INVENTION

Description will now be given in detail according to exemplary embodiments disclosed herein, with reference to the accompanying drawings. For the sake of brief description with reference to the drawings, the same or equivalent components may be provided with the same reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with or to” another element, the element can be connected with the other element or intervening elements may also be present. In contrast, when an element is referred to as being “directly connected with” another element, there are no intervening elements present.

A singular representation may include a plural representation unless it represents a definitely different meaning from the context.

Terms such as “include” or “has” are used herein and should be understood that they are intended to indicate an existence of several components, functions or steps, disclosed in the specification, and it is also understood that greater or fewer components, functions, or steps may likewise be utilized.

Mobile terminals presented herein may be implemented using a variety of different types of terminals. Examples of such terminals include cellular phones, smart phones, user equipment, laptop computers, digital broadcast terminals, Personal Digital Assistants (PDAs), Portable Multimedia Players (PMPs), navigators, slate PCs, tablet PCs, ultra books, wearable devices (for example, smart watches, smart glasses, Head Mounted Displays (HMDs)), and the like.

By way of non-limiting example only, further description will be made with reference to particular types of mobile terminals. However, such teachings apply equally to other types of terminals, such as those types noted above. In addition, these teachings may also be applied to stationary terminals such as digital TV, desktop computers, digital signage and the like.

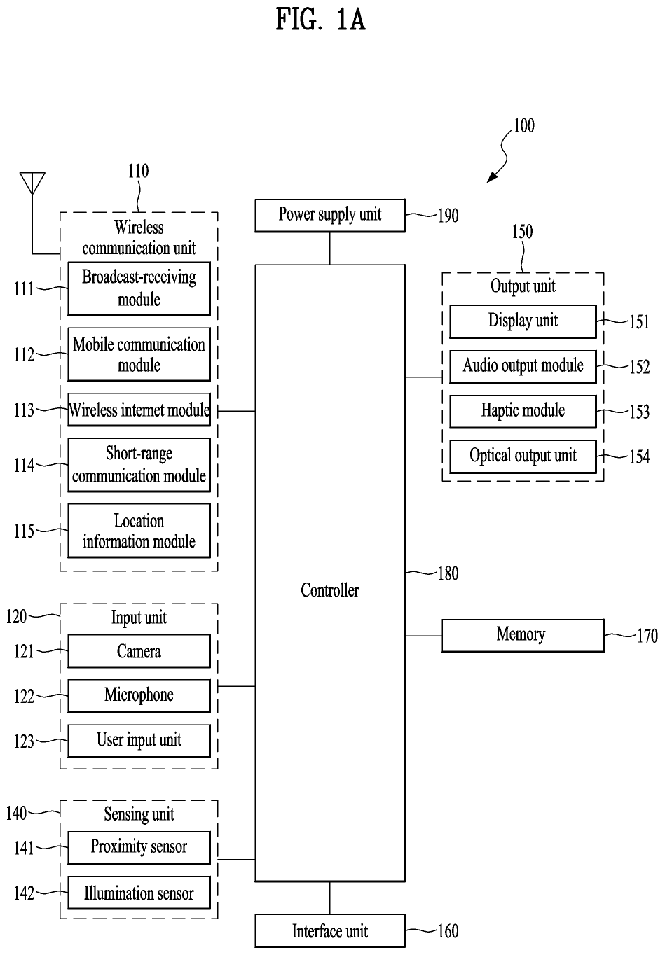

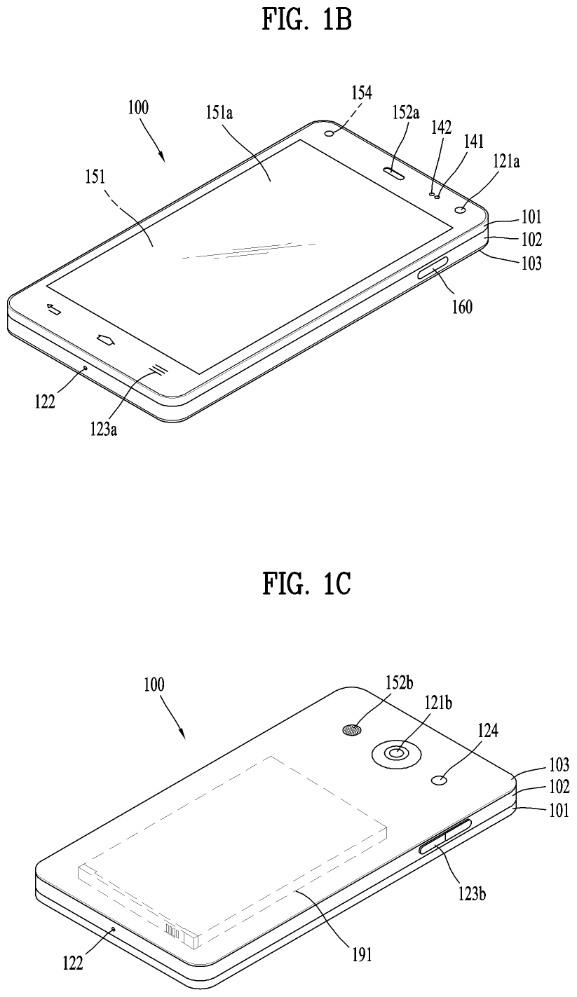

Reference is now made to FIGS. 1A-1C, where FIG. 1A is a block diagram of a mobile terminal in accordance with the present disclosure, and FIGS. 1B and 1C are conceptual views of one example of the mobile terminal, viewed from different directions.

The mobile terminal 100 is shown having components such as a wireless communication unit 110, an input unit 120, a sensing unit 140, an output unit 150, an interface unit 160, a memory 170, a controller 180, and a power supply unit 190. It is understood that implementing all of the illustrated components is not a requirement, and that greater or fewer components may alternatively be implemented. Referring now to FIG. 1A, the mobile terminal 100 is shown having wireless communication unit 110 configured with several commonly implemented components.

The wireless communication unit 110 typically includes one or more modules which permit communications such as wireless communications between the mobile terminal 100 and a wireless communication system, communications between the mobile terminal 100 and another mobile terminal, communications between the mobile terminal 100 and an external server. Further, the wireless communication unit 110 typically includes one or more modules which connect the mobile terminal 100 to one or more networks.

To facilitate such communications, the wireless communication unit 110 includes one or more of a broadcast receiving module 111, a mobile communication module 112, a wireless Internet module 113, a short-range communication module 114 and a position location module 115.

The input unit 120 includes a camera 121 for obtaining images or video, a microphone 122, which is one type of audio input device for inputting an audio signal, and a user input unit 123 (for example, a touch key, a push key, a mechanical key, a soft key, and the like) for allowing a user to input information. Data (for example, audio, video, image, and the like) is obtained by the input unit 120 and may be analyzed and processed by controller 180 according to device parameters, user commands, and combinations thereof.

The sensing unit 140 is typically implemented using one or more sensors configured to sense internal information of the mobile terminal, the surrounding environment of the mobile terminal, user information, and the like. For example, in FIG. 1A, the sensing unit 140 is shown having a proximity sensor 141 and an illumination sensor 142. If desired, the sensing unit 140 may alternatively or additionally include other types of sensors or devices, such as a touch sensor, an acceleration sensor, a magnetic sensor, a G-sensor, a gyroscope sensor, a motion sensor, an RGB sensor, an infrared (IR) sensor, a finger scan sensor, a ultrasonic sensor, an optical sensor (for example, camera 121), a microphone 122, a battery gauge, an environment sensor (for example, a barometer, a hygrometer, a thermometer, a radiation detection sensor, a thermal sensor, and a gas sensor, among others), and a chemical sensor (for example, an electronic nose, a health care sensor, a biometric sensor, and the like), to name a few. The mobile terminal 100 may be configured to utilize information obtained from sensing unit 140, and in particular, information obtained from one or more sensors of the sensing unit 140, and combinations thereof.

The output unit 150 is typically configured to output various types of information, such as audio, video, tactile output, and the like. The output unit 150 is shown having a display unit 151, an audio output module 152, a haptic module 153, and an optical output module 154. The display unit 151 may have an inter-layered structure or an integrated structure with a touch sensor in order to facilitate a touch screen. The touch screen may provide an output interface between the mobile terminal 100 and a user, as well as function as the user input unit 123 which provides an input interface between the mobile terminal 100 and the user.

The interface unit 160 serves as an interface with various types of external devices that can be coupled to the mobile terminal 100. The interface unit 160, for example, may include any of wired or wireless ports, external power supply ports, wired or wireless data ports, memory card ports, ports for connecting a device having an identification module, audio input/output (I/O) ports, video I/O ports, earphone ports, and the like. In some cases, the mobile terminal 100 may perform assorted control functions associated with a connected external device, in response to the external device being connected to the interface unit 160.

The memory 170 is typically implemented to store data to support various functions or features of the mobile terminal 100. For instance, the memory 170 may be configured to store application programs executed in the mobile terminal 100, data or instructions for operations of the mobile terminal 100, and the like. Some of these application programs may be downloaded from an external server via wireless communication. Other application programs may be installed within the mobile terminal 100 at time of manufacturing or shipping, which is typically the case for basic functions of the mobile terminal 100 (for example, receiving a call, placing a call, receiving a message, sending a message, and the like). It is common for application programs to be stored in the memory 170, installed in the mobile terminal 100, and executed by the controller 180 to perform an operation (or function) for the mobile terminal 100.

The controller 180 typically functions to control overall operation of the mobile terminal 100, in addition to the operations associated with the application programs. The controller 180 processes signals, data, information and the like inputted or outputted through the above-mentioned components and/or runs application programs saved in the memory 170, thereby processing or providing a user with appropriate information and/or functions.

The controller 180 may provide or process information or functions appropriate for a user by processing signals, data, information and the like, which are input or output by the various components depicted in FIG. 1A, or activating application programs stored in the memory 170. As one example, the controller 180 controls some or all of the components illustrated in FIG. 1A according to the execution of an application program that have been stored in the memory 170.

The power supply unit 190 can be configured to receive external power or provide internal power in order to supply appropriate power required for operating elements and components included in the mobile terminal 100. The power supply unit 190 may include a battery, and the battery may be configured to be embedded in the terminal body, or configured to be detachable from the terminal body.

At least one portion of the respective components mentioned in the foregoing description can cooperatively operate to embody operations, controls or controlling methods of the mobile terminal according to various embodiments of the present invention mentioned in the following description. Moreover, the operations, controls or controlling methods of the mobile terminal can be embodied in the mobile terminal by running at least one or more application programs saved in the memory 170.

Referring still to FIG. 1A, various components depicted in this figure will now be described in more detail.

Regarding the wireless communication unit 110, the broadcast receiving module 111 is typically configured to receive a broadcast signal and/or broadcast associated information from an external broadcast managing entity via a broadcast channel. The broadcast channel may include a satellite channel, a terrestrial channel, or both. In some embodiments, two or more broadcast receiving modules 111 may be utilized to facilitate simultaneously receiving of two or more broadcast channels, or to support switching among broadcast channels.

The broadcast management server generates a broadcast signal and/or broadcast-related information, and receives the transmitting server or the generated broadcasting signal and/or broadcasting related information, may indicate a server that transmits to a terminal. The broadcast signal includes a TV broadcast signal, a radio broadcast signal, and a data broadcast signal, as well as a TV broadcast signal or it is also possible to include a broadcast signal in which a data broadcast signal is combined with a radio broadcast signal.

The broadcast signal may be encoded according to at least one of the technical standards (or broadcasting system, for example, ISO, IEC, DVB) for transmitting and receiving digital broadcast signals. And the broadcast receiving module 111 can receive the digital broadcast signal using a method conforming to the technical standards defined in the technical standards.

The broadcast-related information may indicate a broadcast channel, a broadcast program, or information related to broadcast service provider. The broadcast-related information can also be provided through a mobile communication network. In this case, the mobile communication module 112 may receive the broadcast-related information.

The broadcast-related information includes, for example, a DMB (Digital Multimedia Broadcasting), EPG (Electronic Program Guide) or an ESG (Electronic Service Guide) of a DVB-H (Digital Video Broadcast-Handheld). The broadcast signal and/or broadcast related information received through the broadcast receiving module 111 may be stored in the memory 170.

The mobile communication module 112 can transmit and/or receive wireless signals to and from one or more network entities. Typical examples of a network entity include a base station, an external mobile terminal, a server, and the like. Such network entities form part of a mobile communication network, which is constructed according to technical standards or communication methods for mobile communications (for example, Global System for Mobile Communication (GSM), Code Division Multi Access (CDMA), CDMA2000(Code Division Multi Access 2000), EV-DO(Enhanced Voice-Data Optimized or Enhanced Voice-Data Only), Wideband CDMA (WCDMA), High Speed Downlink Packet access (HSDPA), HSUPA(High Speed Uplink Packet Access), Long Term Evolution (LTE), LTE-A(Long Term Evolution-Advanced), and the like).

Examples of wireless signals transmitted and/or received via the mobile communication module 112 include audio call signals, video (telephony) call signals, or various formats of data to support communication of text and multimedia messages.

The wireless Internet module 113 is configured to facilitate wireless Internet access. This module may be internally or externally coupled to the mobile terminal 100. The wireless Internet module 113 may transmit and/or receive wireless signals via communication networks according to wireless Internet technologies.

Examples of such wireless Internet access include Wireless LAN (WLAN), Wireless Fidelity (Wi-Fi), Wi-Fi Direct, Digital Living Network Alliance (DLNA), Wireless Broadband (WiBro), Worldwide Interoperability for Microwave Access (WiMAX), High Speed Downlink Packet Access (HSDPA), HSUPA(High Speed Uplink Packet Access), Long Term Evolution (LTE), LTE-A(Long Term Evolution-Advanced), and the like. The wireless Internet module 113 may transmit/receive data according to one or more of such wireless Internet technologies, and other Internet technologies as well.

In some embodiments, when the wireless Internet access is implemented according to, for example, WiBro, HSDPA,HSUPA, GSM, CDMA, WCDMA, LTE, LTE-A and the like, as part of a mobile communication network, the wireless Internet module 113 performs such wireless Internet access. As such, the Internet module 113 may cooperate with, or function as, the mobile communication module 112.

The short-range communication module 114 is configured to facilitate short-range communications. Suitable technologies for implementing such short-range communications include BLUETOOTH™, Radio Frequency IDentification (RFID), Infrared Data Association (IrDA), Ultra-WideBand (UWB), ZigBee, Near Field Communication (NFC), Wireless-Fidelity (Wi-Fi). Wi-Fi Direct, Wireless USB(Wireless Universal Serial Bus), and the like. The short-range communication module 114 in general supports wireless communications between the mobile terminal 100 and a wireless communication system, communications between the mobile terminal 100 and another mobile terminal 100, or communications between the mobile terminal and a network where another mobile terminal 100 (or an external server) is located, via wireless area networks. One example of the wireless area networks is a wireless personal area networks.

In some embodiments, another mobile terminal (which may be configured similarly to mobile terminal 100) may be a wearable device, for example, a smart watch, a smart glass or a head mounted display (HMD), which is able to exchange data with the mobile terminal 100 (or otherwise cooperate with the mobile terminal 100). The short-range communication module 114 may sense or recognize the wearable device, and permit communication between the wearable device and the mobile terminal 100. In addition, when the sensed wearable device is a device which is authenticated to communicate with the mobile terminal 100, the controller 180, for example, may cause transmission of data processed in the mobile terminal 100 to the wearable device via the short-range communication module 114. Hence, a user of the wearable device may use the data processed in the mobile terminal 100 on the wearable device. For example, when a call is received in the mobile terminal 100, the user may answer the call using the wearable device. Also, when a message is received in the mobile terminal 100, the user can check the received message using the wearable device.

The position-location module 115 is generally configured to detect, calculate, derive or otherwise identify a position of the mobile terminal. As an example, the position-location module 115 includes a Global Position System (GPS) module, a Wi-Fi module, or both. If desired, the position-location module 115 may alternatively or additionally function with any of the other modules of the wireless communication unit 110 to obtain data related to the position of the mobile terminal. As one example, when the mobile terminal uses a GPS module, a position of the mobile terminal may be acquired using a signal sent from a GPS satellite. As another example, when the mobile terminal uses the Wi-Fi module, a position of the mobile terminal can be acquired based on information related to a wireless access point (AP) which transmits or receives a wireless signal to or from the Wi-Fi module.

The input unit 120 may be configured to permit various types of input to the mobile terminal 100. Examples of such input include audio, image, video, data, and user input. Image and video input is often obtained using one or more cameras 121. Such cameras 121 may process image frames of still pictures or video obtained by image sensors in a video or image capture mode. The processed image frames can be displayed on the display unit 151 or stored in memory 170. In some cases, the cameras 121 may be arranged in a matrix configuration to permit a plurality of images having various angles or focal points to be input to the mobile terminal 100. As another example, the cameras 121 may be located in a stereoscopic arrangement to acquire left and right images for implementing a stereoscopic image.

The microphone 122 is generally implemented to permit audio input to the mobile terminal 100. The audio input can be processed in various manners according to a function being executed in the mobile terminal 100. If desired, the microphone 122 may include assorted noise removing algorithms to remove unwanted noise generated in the course of receiving the external audio.

The user input unit 123 is a component that permits input by a user. Such user input may enable the controller 180 to control operation of the mobile terminal 100. The user input unit 123 may include one or more of a mechanical input element (for example, a key, a button located on a front and/or rear surface or a side surface of the mobile terminal 100, a dome switch, a jog wheel, a jog switch, and the like), or a touch-sensitive input, among others. As one example, the touch-sensitive input may be a virtual key or a soft key, which is displayed on a touch screen through software processing, or a touch key which is located on the mobile terminal at a location that is other than the touch screen. On the other hand, the virtual key or the visual key may be displayed on the touch screen in various shapes, for example, graphic, text, icon, video, or a combination thereof.

The sensing unit 140 is generally configured to sense one or more of internal information of the mobile terminal, surrounding environment information of the mobile terminal, user information, or the like. The controller 180 generally cooperates with the sending unit 140 to control operation of the mobile terminal 100 or execute data processing, a function or an operation associated with an application program installed in the mobile terminal based on the sensing provided by the sensing unit 140. The sensing unit 140 may be implemented using any of a variety of sensors, some of which will now be described in more detail.

The proximity sensor 141 may include a sensor to sense presence or absence of an object approaching a surface, or an object located near a surface, by using an electromagnetic field, infrared rays, or the like without a mechanical contact. The proximity sensor 141 may be arranged at an inner region of the mobile terminal covered by the touch screen, or near the touch screen.

The proximity sensor 141, for example, may include any of a transmissive type photoelectric sensor, a direct reflective type photoelectric sensor, a mirror reflective type photoelectric sensor, a high-frequency oscillation proximity sensor, a capacitance type proximity sensor, a magnetic type proximity sensor, an infrared rays proximity sensor, and the like. When the touch screen is implemented as a capacitance type, the proximity sensor 141 can sense proximity of a pointer relative to the touch screen by changes of an electromagnetic field, which is responsive to an approach of an object with conductivity. In this case, the touch screen (touch sensor) may also be categorized as a proximity sensor.

The term “proximity touch” will often be referred to herein to denote the scenario in which a pointer is positioned to be proximate to the touch screen without contacting the touch screen. The term “contact touch” will often be referred to herein to denote the scenario in which a pointer makes physical contact with the touch screen. For the position corresponding to the proximity touch of the pointer relative to the touch screen, such position will correspond to a position where the pointer is perpendicular to the touch screen. The proximity sensor 141 may sense proximity touch, and proximity touch patterns (for example, distance, direction, speed, time, position, moving status, and the like).

In general, controller 180 processes data corresponding to proximity touches and proximity touch patterns sensed by the proximity sensor 141, and cause output of visual information on the touch screen. In addition, the controller 180 can control the mobile terminal 100 to execute different operations or process different data according to whether a touch with respect to a point on the touch screen is either a proximity touch or a contact touch.

A touch sensor can sense a touch applied to the touch screen, such as display unit 151, using any of a variety of touch methods. Examples of such touch methods include a resistive type, a capacitive type, an infrared type, and a magnetic field type, among others. As one example, the touch sensor may be configured to convert changes of pressure applied to a specific part of the display unit 151, or convert capacitance occurring at a specific part of the display unit 151, into electric input signals. The touch sensor may also be configured to sense not only a touched position and a touched area, but also touch pressure and/or touch capacitance. A touch object is generally used to apply a touch input to the touch sensor. Examples of typical touch objects include a finger, a touch pen, a stylus pen, a pointer, or the like.

When a touch input is sensed by a touch sensor, corresponding signals may be transmitted to a touch controller. The touch controller may process the received signals, and then transmit corresponding data to the controller 180. Accordingly, the controller 180 may sense which region of the display unit 151 has been touched. Here, the touch controller may be a component separate from the controller 180, the controller 180, and combinations thereof.

In some embodiments, the controller 180 may execute the same or afferent controls according to a type of touch object that touches the touch screen or a touch key provided in addition to the touch screen. Whether to execute the same or different control according to the object which provides a touch input may be decided based on a current operating state of the mobile terminal 100 or a currently executed application program, for example.

The touch sensor and the proximity sensor may be implemented individually, or in combination, to sense various types of touches. Such touches includes a short (or tap) touch, a long touch, a multi-touch, a drag touch, a flick touch, a pinch-in touch, a pinch-out touch, a swipe touch, a hovering touch, and the like.

If desired, an ultrasonic sensor may be implemented to recognize position information relating to a touch object using ultrasonic waves. The controller 180, for example, may calculate a position of a wave generation source based on information sensed by an illumination sensor and a plurality of ultrasonic sensors. Since light is much faster than ultrasonic waves, the time for which the light reaches the optical sensor is much shorter than the time for which the ultrasonic wave reaches the ultrasonic sensor. The position of the wave generation source may be calculated using this fact. For instance, the position of the wave generation source may be calculated using the time difference from the time that the ultrasonic wave reaches the sensor based on the light as a reference signal.

The camera 121 typically includes at least one a camera sensor (CCD, CMOS etc.), a photo sensor (or image sensors), and a laser sensor.

Implementing the camera 121 with a laser sensor may allow detection of a touch of a physical object with respect to a 3D stereoscopic image. The photo sensor may be laminated on, or overlapped with, the display device. The photo sensor may be configured to scan movement of the physical object in proximity to the touch screen. In more detail, the photo sensor may include photo diodes and transistors at rows and columns to scan content received at the photo sensor using an electrical signal which changes according to the quantity of applied light. Namely, the photo sensor may calculate the coordinates of the physical object according to variation of light to thus obtain position information of the physical object.

The display unit 151 is generally configured to output information processed in the mobile terminal 100. For example, the display unit 151 may display execution screen information of an application program executing at the mobile terminal 100 or user interface (UI) and graphic user interface (GUI) information in response to the execution screen information.

In some embodiments, the display unit 151 may be implemented as a stereoscopic display unit for displaying stereoscopic images.

A typical stereoscopic display unit may employ a stereoscopic display scheme such as a stereoscopic scheme (a glass scheme), an auto-stereoscopic scheme (glassless scheme), a projection scheme (holographic scheme), or the like.

Generally, 3D stereoscopic images are composed of left image (left eye image) and right image). According to the way in which left and right images are combined into three-dimensional stereoscopic images, a top-down method in which left and right images are arranged vertically in one frame, method, a left-to-right (L-to-R) side-by-side method in which left and right images are arranged left and right in one frame, board (checker board) method, the left image and the right image are alternately arranged in a column unit or a row unit interlaced, and left and right images by time sequential (frame-by-frame) method.

In addition, the 3D thumbnail image is obtained from the left and right images of the original image frame a left-image thumbnail and a right-image thumbnail, respectively, and as they are combined and can be generated as one image. Generally, a thumbnail is a reduced image or a reduced still image. The generated left image thumbnail and right image the thumbnail is displayed on the screen by a depth corresponding to the parallax between the left and right images by displaying the difference between the left and right distances, it is possible to exhibit stereoscopic spatial feeling.

The left and right images required for the implementation of the three-dimensional image are processed by the stereoscopic processing unit and can be displayed on the stereoscopic display unit. The stereoscopic processing unit displays 3D images and the image of the extension point of time) from the left image and the right image, or a 2D image is inputted and converted into a left image and a right image.

The audio output module 152 is generally configured to output audio data. Such audio data may be obtained from any of a number of different sources, such that the audio data may be received from the wireless communication unit 110 or may have been stored in the memory 170. The audio data may be output during modes such as a signal reception mode, a call mode, a record mode, a voice recognition mode, a broadcast reception mode, and the like. The audio output module 152 can provide audible output related to a particular function (e.g., a call signal reception sound, a message reception sound, etc.) performed by the mobile terminal 100. The audio output module 152 may also be implemented as a receiver, a speaker, a buzzer, or the like.

A haptic module 153 can be configured to generate various tactile effects that a user feels, perceive, or otherwise experience. A typical example of a tactile effect generated by the haptic module 153 is vibration. The strength, pattern and the like of the vibration generated by the haptic module 153 can be controlled by user selection or setting by the controller. For example, the haptic module 153 may output different vibrations in a combining manner or a sequential manner.

Besides vibration, the haptic module 153 can generate various other tactile effects, including an effect by stimulation such as a pin arrangement vertically moving to contact skin, a spray force or suction force of air through a jet orifice or a suction opening, a touch to the skin, a contact of an electrode, electrostatic force, an effect by reproducing the sense of cold and warmth using an element that can absorb or generate heat, and the like.

The haptic module 153 can also be implemented to allow the user to feel a tactile effect through a muscle sensation such as the user's fingers or arm, as well as transferring the tactile effect through direct contact. Two or more haptic modules 153 may be provided according to the particular configuration of the mobile terminal 100.

An optical output module 154 can output a signal for indicating an event generation using light of a light source. Examples of events generated in the mobile terminal 100 may include message reception, call signal reception, a missed call, an alarm, a schedule notice, an email reception, information reception through an application, and the like.

A signal output by the optical output module 154 may be implemented in such a manner that the mobile terminal emits monochromatic light or light with a plurality of colors. The signal output may be terminated as the mobile terminal senses that a user has checked the generated event, for example.

The interface unit 160 serves as an interface for external devices to be connected with the mobile terminal 100. For example, the interface unit 160 can receive data transmitted from an external device, receive power to transfer to elements and components within the mobile terminal 100, or transmit internal data of the mobile terminal 100 to such external device. The interface unit 160 may include wired or wireless headset ports, external power supply ports, wired or wireless data ports, memory card ports, ports for connecting a device having an identification module, audio input/output (I/O) ports, video I/O ports, earphone ports, or the like.

The identification module may be a chip that stores various information for authenticating authority of using the mobile terminal 100 and may include a user identity module (UIM), a subscriber identity module (SIM), a universal subscriber identity module (USIM), and the like. In addition, the device having the identification module (also referred to herein as an “identifying device”) may take the form of a smart card. Accordingly, the identifying device can be connected with the terminal 100 via the interface unit 160.

When the mobile terminal 100 is connected with an external cradle, the interface unit 160 can serve as a passage to allow power from the cradle to be supplied to the mobile terminal 100 or may serve as a passage to allow various command signals input by the user from the cradle to be transferred to the mobile terminal there through. Various command signals or power input from the cradle may operate as signals for recognizing that the mobile terminal is properly mounted on the cradle.

The memory 170 can store programs to support operations of the controller 180 and store input/output data (for example, phonebook, messages, still images, videos, etc.). The memory 170 may store data related to various patterns of vibrations and audio which are output in response to touch inputs on the touch screen.

The memory 170 may include one or more types of storage mediums including a Flash memory, a hard disk, a solid state disk, a silicon disk, a multimedia card micro type, a card-type memory (e.g., SD or DX memory, etc), a Random Access Memory (RAM), a Static Random Access Memory (SRAM), a Read-Only Memory (ROM), an Electrically Erasable Programmable Read-Only Memory (EEPROM), a Programmable Read-Only memory (PROM), a magnetic memory, a magnetic disk, an optical disk, and the like. The mobile terminal 100 may also be operated in relation to a network storage device that performs the storage function of the memory 170 over a network, such as the Internet.

The controller 180 may typically control the general operations of the mobile terminal 100. For example, the controller 180 may set or release a lock state for restricting a user from inputting a control command with respect to applications when a status of the mobile terminal meets a preset condition.

The controller 180 can also perform the controlling and processing associated with voice calls, data communications, video calls, and the like, or perform pattern recognition processing to recognize a handwriting input or a picture drawing input performed on the touch screen as characters or images, respectively. In addition, the controller 180 can control one or a combination of those components in order to implement various exemplary embodiments disclosed herein.

The power supply unit 190 can receive external power or provide internal power and supply the appropriate power required for operating respective elements and components included in the mobile terminal 100. The power supply unit 190 may include a battery, which is typically rechargeable or be detachably coupled to the terminal body for charging.

Also, the power supply unit 190 may include a connection port. The connection port may be configured as one example of the interface unit 160 to which an external charger for supplying power to recharge the battery is electrically connected.

As another example, the power supply unit 190 may be configured to recharge the battery in a wireless manner without use of the connection port. In this example, the power supply unit 190 can receive power, transferred from an external wireless power transmitter, using at least one of an inductive coupling method which is based on magnetic induction or a magnetic resonance coupling method which is based on electromagnetic resonance.

Also, various embodiments can be implemented in the computer and similar recording materials using software, hardware and the combination of software and hardware.

Referring now to FIGS. 1B and 1C, the mobile terminal 100 is described with reference to a bar-type terminal body. However, the mobile terminal 100 may alternatively be implemented in any of a variety of different configurations. Examples of such configurations include watch-type, clip-type, glasses-type, or as a folder-type, flip-type, slide-type, swing-type, and swivel-type in which two and more bodies are combined with each other in a relatively movable manner, and combinations thereof. Discussion herein will often relate to a particular type of mobile terminal (for example, bar-type, watch-type, glasses-type, and the like). However, such teachings with regard to a particular type of mobile terminal will generally apply to other types of mobile terminals as well.

The mobile terminal 100 will generally include a case (for example, frame, housing, cover, and the like) forming the appearance of the terminal.

In this embodiment, the case is formed using a front case 101 and a rear case 102. Various electronic components are incorporated into a space formed between the front case 101 and the rear case 102. At least one middle case may be additionally positioned between the front case 101 and the rear case 102.

The display unit 151 is shown located on the front side of the terminal body to output information. As illustrated, a window 151a of the display unit 151 may be mounted to the front case 101 to form the front surface of the terminal body together with the front case 101.

In some embodiments, electronic components may also be mounted to the rear case 102. Examples of such electronic components include a detachable battery 191, an identification module, a memory card, and the like. Rear cover 103 is shown covering the electronic components, and this cover may be detachably coupled to the rear case 102. Therefore, when the rear cover 103 is detached from the rear case 102, the electronic components mounted to the rear case 102 are externally exposed.

As illustrated, when the rear cover 103 is coupled to the rear case 102, a side surface of the rear case 102 is partially exposed. In some cases, upon the coupling, the rear case 102 may also be completely shielded by the rear cover 103. In some embodiments, the rear cover 103 may include an opening for externally exposing a camera 121b or an audio output module 152b.

The cases 101, 102, 103 may be formed by injection-molding synthetic resin or may be formed of a metal, for example, stainless steel (STS), aluminum (Al), titanium (Ti), or the like.

As an alternative to the example in which the plurality of cases form an inner space for accommodating components, the mobile terminal 100 may be configured such that one case forms the inner space. In this example, a mobile terminal 100 having a uni-body is formed in such a manner that synthetic resin or metal extends from a side surface to a rear surface.

If desired, the mobile terminal 100 may include a waterproofing unit (not shown) for preventing introduction of water into the terminal body. For example, the waterproofing unit may include a waterproofing member which is located between the window 151a and the front case 101, between the front case 101 and the rear case 102, or between the rear case 102 and the rear cover 103, to hermetically seal an inner space when those cases are coupled.

The mobile terminal 100 may be provided with the display unit 151, the 1st audio output unit 152a, the 2nd audio output unit 152b, the proximity sensor 141, the illumination sensor 142, the light output unit 154, the 1st camera 121a, the 2nd camera 121b, the 1st manipulating unit 123a, the 2nd manipulating unit 123b, the microphone 122, the interface unit 160, and the like.

FIGS. 1B and 1C depict certain components as arranged on the mobile terminal.

However, it is to be understood that alternative arrangements are possible and within the teachings of the instant disclosure. Some components may be omitted or rearranged. For example, the first manipulation unit 123a may be located on another surface of the terminal body, and the second audio output module 152b may be located on the side surface of the terminal body.

The display unit 151 outputs information processed in the mobile terminal 100. The display unit 151 may be implemented using one or more suitable display devices.

Examples of such suitable display devices include a liquid crystal display (LCD), a thin film transistor-liquid crystal display (TFT-LCD), an organic light emitting diode (OLED), a flexible display, a 3-dimensional (3D) display, an e-ink display, and combinations thereof.

The display unit 151 may be implemented using two display devices, which can implement the same or different display technology. For instance, a plurality of the display units 151 may be arranged on one side, either spaced apart from each other, or these devices may be integrated, or these devices may be arranged on different surfaces.

The display unit 151 may also include a touch sensor which senses a touch input received at the display unit. When a touch is input to the display unit 151, the touch sensor may be configured to sense this touch and the controller 180, for example, may generate a control command or other signal corresponding to the touch. The content which is input in the touching manner may be a text or numerical value, or a menu item which can be indicated or designated in various modes.

The touch sensor may be configured in a form of a film having a touch pattern, disposed between the window 151a and a display on a rear surface of the window 151a, or a metal wire which is patterned directly on the rear surface of the window 151a. Alternatively, the touch sensor may be integrally formed with the display. For example, the touch sensor may be disposed on a substrate of the display or within the display.

The display unit 151 may also form a touch screen together with the touch sensor. Here, the touch screen may serve as the user input unit 123 (see FIG. 1A). Therefore, the touch screen may replace at least some of the functions of the first manipulation unit 123a.

The first audio output module 152a may be implemented in the form of a speaker to output voice audio, alarm sounds, multimedia audio reproduction, and the like.

The window 151a of the display unit 151 will typically include an aperture to permit audio generated by the first audio output module 152a to pass. One alternative is to allow audio to be released along an assembly gap between the structural bodies (for example, a gap between the window 151a and the front case 101). In this case, a hole independently formed to output audio sounds may not be seen or is otherwise hidden in terms of appearance, thereby further simplifying the appearance and manufacturing of the mobile terminal 100.

The optical output module 154 can be configured to output light for indicating an event generation. Examples of such events include a message reception, a call signal reception, a missed call, an alarm, a schedule notice, an email reception, information reception through an application, and the like. When a user has checked a generated event, the controller can control the optical output unit 154 to stop the light output.

The first camera 121a can process image frames such as still or moving images obtained by the image sensor in a capture mode or a video call mode. The processed image frames can then be displayed on the display unit 151 or stored in the memory 170.

The first and second manipulation units 123a and 123b may also be commonly referred to as a manipulating portion, and may employ any tactile method that allows the user to perform manipulation such as touch, push, scroll, or the like. The first and second manipulation units 123a and 123b may also employ any non-tactile method that allows the user to perform manipulation such as proximity touch, hovering, or the like.

In the figure, the first operation unit 123a is a touch key, the invention is not limited thereto. For example, the first operation unit 123a a mechanical key, or a combination of a touch key and a touch key.

The contents input by the first and second operation units 123a and 123b are variously set can be. For example, the first operation unit 123a may issue a command such as a menu, a home key, a cancel, and the second operation unit 123b receives the first sound output from the first or second sound output unit 152a or 152b the size of the sound to be output, and the switch to the touch recognition mode of the display unit 151 can be input.

The rear input unit can be manipulated by a user to provide input to the mobile terminal 100. The input may be used in a variety of different ways. For example, the rear input unit may be used by the user to provide an input for power on/off, start, end, scroll, control volume level being output from the first or second audio output modules 152a or 152b, switch to a touch recognition mode of the display unit 151, and the like. The rear input unit may be configured to permit touch input, a push input, or combinations thereof.

The rear input unit may be located to overlap the display unit 151 of the front side in a thickness direction of the terminal body. As one example, the rear input unit may be located on an upper end portion of the rear side of the terminal body such that a user can easily manipulate it using a forefinger when the user grabs the terminal body with one hand. Alternatively, the rear input unit can be positioned at most any location of the rear side of the terminal body.

Embodiments that include the rear input unit may implement some or all of the functionality of the first manipulation unit 123a in the rear input unit. As such, in situations where the first manipulation unit 123a is omitted from the front side, the display unit 151 can have a larger screen.

As a further alternative, the mobile terminal 100 may include a finger scan sensor which scans a user's fingerprint. The controller 180 can then use fingerprint information sensed by the finger scan sensor as part of an authentication procedure. The finger scan sensor may also be installed in the display unit 151 or implemented in the user input unit 123.

The microphone 122 is shown located at an end of the mobile terminal 100, but other locations are possible. If desired, multiple microphones may be implemented, with such an arrangement permitting the receiving of stereo sounds.

The interface unit 160 may serve as a path allowing the mobile terminal 100 to interface with external devices. For example, the interface unit 160 may include one or more of a connection terminal for connecting to another device (for example, an earphone, an external speaker, or the like), a port for near field communication (for example, an Infrared Data Association (IrDA) port, a Bluetooth port, a wireless LAN port, and the like), or a power supply terminal for supplying power to the mobile terminal 100. The interface unit 160 may be implemented in the form of a socket for accommodating an external card, such as Subscriber Identification Module (SIM), User Identity Module (UIM), or a memory card for information storage.

The second camera 121b is shown located at the rear side of the terminal body and includes an image capturing direction that is substantially opposite to the image capturing direction of the first camera unit 121a. If desired, second camera 121a may alternatively be located at other locations, or made to be moveable, in order to have a different image capturing direction from that which is shown.

The second camera 121b can include a plurality of lenses arranged along at least one line. The plurality of lenses may also be arranged in a matrix configuration. The cameras may be referred to as an “array camera.” When the second camera 121b is implemented as an array camera, images may be captured in various manners using the plurality of lenses and images with better qualities.

As shown in FIG. 1C, a flash 124 is shown adjacent to the second camera 121b. When an image of a subject is captured with the camera 121b, the flash 124 may illuminate the subject.

As shown in FIG. 1B, the second audio output module 152b can be located on the terminal body. The second audio output module 152b may implement stereophonic sound functions in conjunction with the first audio output module 152a, and may be also used for implementing a speaker phone mode for call communication.

At least one antenna for wireless communication may be located on the terminal body. The antenna may be installed in the terminal body or formed by the case. For example, an antenna which configures a part of the broadcast receiving module 111 may be retractable into the terminal body. Alternatively, an antenna may be formed using a film attached to an inner surface of the rear cover 103, or a case that includes a conductive material.

A power supply unit 190 for supplying power to the mobile terminal 100 may include a battery 191, which is mounted in the terminal body or detachably coupled to an outside of the terminal body. The battery 191 may receive power via a power source cable connected to the interface unit 160.

Also, the battery 191 can be recharged in a wireless manner using a wireless charger. Wireless charging may be implemented by magnetic induction or electromagnetic resonance.

The rear cover 103 is shown coupled to the rear case 102 for shielding the battery 191, to prevent separation of the battery 191, and to protect the battery 191 from an external impact or from foreign material. When the battery 191 is detachable from the terminal body, the rear case 103 may be detachably coupled to the rear case 102.

An accessory for protecting an appearance or assisting or extending the functions of the mobile terminal 100 can also be provided on the mobile terminal 100. As one example of an accessory, a cover or pouch for covering or accommodating at least one surface of the mobile terminal 100 may be provided. The cover or pouch may cooperate with the display unit 151 to extend the function of the mobile terminal 100. Another example of the accessory is a touch pen for assisting or extending a touch input to a touch screen.

Meanwhile, in the present invention, it can be displayed using a flexible display. In the following, this will be discussed in more detail with attached drawings.

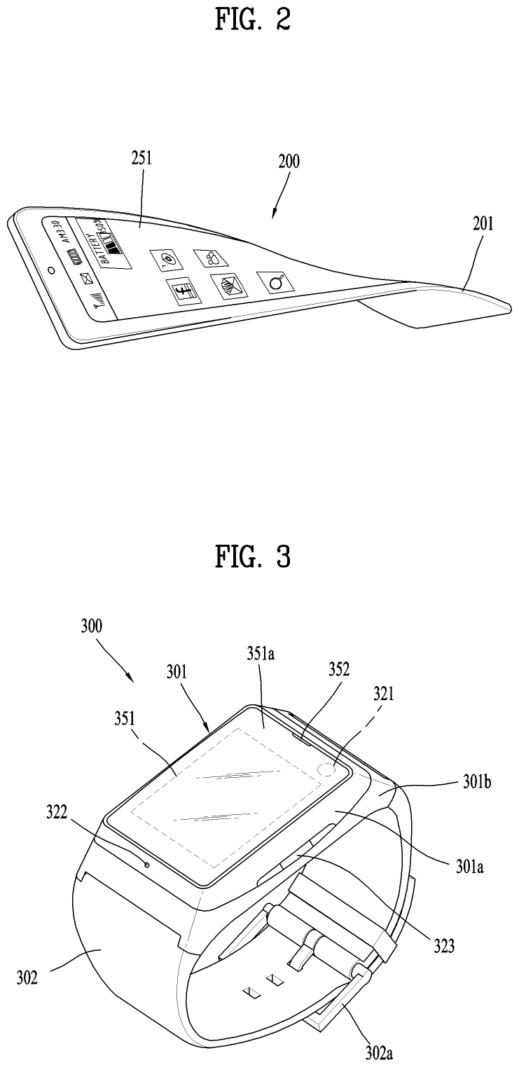

FIG. 2 is a conceptual view to describe another example of a deformable mobile terminal 200 according to the present invention.

Referring to FIG. 2, a display unit 251 may be configured deformable in response to an external force. This deformation may include at last one of curving, bending, folding, twisting, rolling, and combinations thereof. The deformable display unit 251 may be named “flexible display unit”. In particular, the flexible display unit 251 may include a general flexible display, an electronic paper (also known as e-paper), and a combination thereof. In general, a mobile terminal 200 may be configured to include the same or similar features of the former mobile terminal 100 shown in FIGS. 1A to 1C.

Generally, a flexible display means a display that is light-weighted and non-fragile in a manner of being fabricated on a thin and flexible substrate having such properties of paper as curving, bending, folding, twisting, and rolling while maintaining the properties of an existing flat panel display.

The e-paper may be used to refer to a display technology that employs the properties of a general ink. The e-paper is different from the existing flat panel display in using reflective light. The e-paper is generally understood as changing displayed information by electrophoresis using twist balls or capsules.

In a state that the flexible display unit 251 is not deformed (for example, a state that the flexible display unit 251 has an infinite radius of curvature, referred to as a 1^{st} state), a display region of the flexible display unit 251 becomes a flat surface. In a state that the flexible display unit 251 is deformed from the 1^{st} state by an external force (for example, a state that the flexible display unit 251 has a finite radius of curvature, referred to as a 2^{nd} state), the display region may become a curved surface or a bent surface. As illustrated, information displayed in the second state may include a visual information outputted through the curved surface. The visual information may be implemented in a manner that light emission of each unit pixel (sub-pixel) arranged in a matrix configuration is controlled independently. In this case, the unit pixel denotes an elementary unit for representing a single color.

The flexible display unit 251 may enter not a flat state but a curved state (for example, a vertically curved state, a horizontally curved state, etc.) in the 1^{st} state. In doing so, if an external force is applied to the flexible display unit 251, the flexible display unit 251 may be deformed into a flat state (or a less curved state) or a more curved state.

If desired, the flexible display unit 251 may embody a flexible touchscreen by being combined with a touch sensor. If a touch is applied to the flexible touchscreen, the controller 180 (cf. FIG. 1A) can perform a control in response to the touch input. The flexible touchscreen may be configured to sense a touch input not only in the 1st state but also in the 2^{nd} state.

Meanwhile, the mobile terminal 200 according to the modified example may include a deformation sensing means for sensing the deformation of the flexible display unit 251. The deformation sensing means may be included in the sensing unit 140 shown in FIG. 1A.

The deformation sensing means is provided to the flexible display unit 251 or the case 201 to sense information related to the deformation of the flexible display unit 251. Examples of such information related to the deformation of the flexible display unit 251 may include a deformed direction of the flexible display unit 251, a deformed degree of the flexible display unit 251, a deformed position of the flexible display unit 251, a deformed time of the flexible display unit 251, an acceleration for restoring the deformed flexible display unit 251, and the like. Besides, the information may include various kinds of information that can be sensed owing to the curving of the flexible display unit 251.

The controller 180 can change the information displayed on the flexible display unit 251 or generate a control signal for controlling a function of the mobile terminal 200, based on the information related to the deformation of the flexible display unit 251. Such information is typically sensed by the deformation sensing means.

The mobile terminal 200 according to the modified example may include a case 201 for accommodating the flexible display unit 251. The case 201 can be configured deformable together with the flexible display unit 251 in consideration of the property of the flexible display unit 251.

A battery (not shown in the drawing) provided to the mobile terminal 200 may be configured deformable by an external force together with the flexible display unit 251 in consideration of the property of the flexible display unit 251. In order to embody such a battery, it is able to employ a stack and folding scheme of stacking, battery cells on each other.

The state deformation of the flexible display unit 251 is non-limited by the case of applying the external force. For example, the flexible display unit 251 can be deformed into the 2^{nd} state in response a command given by a user or application when the flexible display unit 251 is in the 1^{st} state.

Beyond using a mobile terminal grabbed with a user's hand, the mobile terminal may extend to a wearable device that is wearable on a user body. Examples of the wearable device include a smart watch, a smart glass, a head mounted display (HMD), and the like. Examples of the mobile terminal extending to the wearable devices shall be described as follows.

First of all, a typical wearable device can exchange data with (or interwork with) another mobile terminal 100. The short-range communication module 114 can sense or recognize a nearby wearable device capable of communicating with the mobile terminal 100. Moreover, if the sensed wearable device is a device authenticated to communicate with the mobile terminal 100, the controller 180 may transmit at least one portion of the data processed in the mobile terminal 100 to the wearable device via the short-range communication module 114, for example. Hence, a user can use the data processed in the mobile terminal 100 through the wearable device. For example, when an incoming call is received by the mobile terminal 100, the user can answer the incoming call through the wearable device. When a message is received by the mobile terminal 100, the user can check the received message through the wearable device.

FIG. 3 is a perspective diagram for one example of a watch type mobile terminal 300 related to another embodiment of the present invention.

Referring to FIG. 3, a mobile terminal 300 of a watch type may include a main body 301 having a display unit 351 and a band 302 connected to the main body 301 to be wearable on a wrist. In general, the mobile terminal 300 may be configured to include features that are the same or similar to those of the former mobile terminal 100 shown in FIGS. 1A to 1C.

The main body 301 may include a case forming a certain appearance or exterior. As illustrated, the case may include a 1^{st} case 301a and a 2^{nd} case 301b configured to cooperatively provide an inner space for accommodating various electronic components therein, by which the present invention is non-limited. For instance, a single case is configured to provide the inner space, thereby embodying the mobile terminal 300 of a uni-body type.

The watch type mobile terminal 300 is configured to perform wireless communication, and an antenna for the wireless communication can be installed in the main body 301. It is able to expand performance of the antenna using the case. For example, a case containing a conductive material is electrically connected to the antenna to extend a ground region or a radiation region.

The display unit 351 is disposed on the front side of the main body 301 so as to output information. The display unit 351 is provided with a touch sensor so as to be embodied into a touchscreen. As illustrated, a window 351a of the display unit 251 is mounted on the 1^{st} case 301a to form a front surface of the terminal body together with the 1^{st} case 301a.

The main body 301 may be provided with an audio output unit 352, a camera 321, a microphone 322, a user input unit 323 and the like. In case that the display unit 351 is embodiment into the touchscreen, it can function as a user input unit 323. Hence, a separate key may not be provided to the main body 301.

The band 302 is configured to be worn on a wrist by enclosing the wrist. And, the band 302 may be formed of a flexible material for facilitating the wearing of the device. As one example, the band 302 may be made of leather, rubber, silicon, synthetic resin, and/or the like. As the band 302 is configured detachable from the main body 301, the band 302 may be substituted with various types of bands according to a user's preference.

Meanwhile, the band 302 may be used to expand the performance of the antenna. For example, a ground extending portion (not shown in the drawing) for extending a ground region by being electrically connected to the antenna may be built in the band 302.

The band 302 may include a fastener 302a. The fastener 302a may be embodied into a buckle type, a snap-fit hook structure, a Velcro® type, and/or the like. The fastener 302a may include a retractile section or material. According to the example shown in the present drawing, the fastener 302a is embodied into the buckle type.

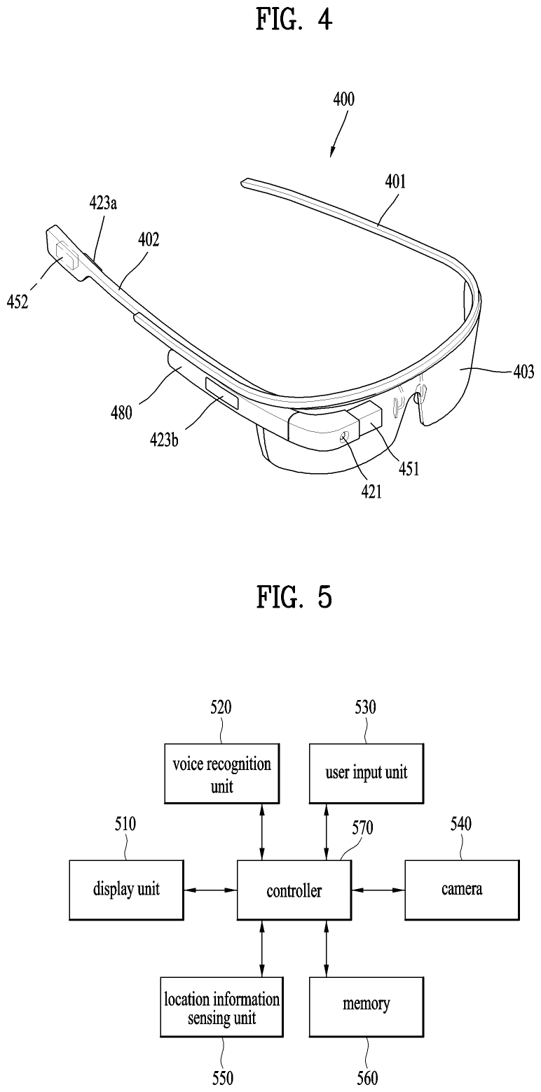

FIG. 4 is a perspective diagram for one example of a glass type mobile terminal 400 related to further embodiment of the present invention.

The glass type mobile terminal 400 is configured wearable on a head of a human body. To this end, the glass type mobile terminal 400 may include a frame unit (e.g., a case, a housing, etc.). The frame unit may be formed of a flexible material to be easily wearable. According to the example shown in the drawing, the frame unit of the mobile terminal 400 includes a 1^{st} frame 401 and a 2^{nd} frame 402, each of which can be made of a different material. In general, the mobile terminal 400 may have the same or similar features of the former mobile terminal 100 shown in FIGS. 1A to 1C.

The frame unit may be supported by the head and provides a space for mounting various components therein. As illustrated, electronic components such as a control module 480, an audio output unit 452 and the like may be installed in the frame unit. And, a lens 403 configured to cover at least one of the left and the right eye may be detachably installed in the frame unit.

The control module 480 is configured to control various electronic components provided to the mobile terminal 400. It may be appreciated that the control module 480 has the configuration corresponding to the aforementioned controller 180. According to the example shown in the present drawing, the control module 480 is installed in the frame unit on one side of the head, by which a location of the control module 480 is non-limited.

The display unit 451 may be embodied into a head mounted display (HMD). The HMD refers to a display system for directly projecting an image in front of user's eyes in a manner of being mounted on the head. In order to provide an image directly in front of the user's eyes, when the user wears the glass type mobile terminal 400, the display unit 451 may be disposed to correspond to at least one of the left eye and the right eye. According to the example shown in the present drawing, the display unit 451 is situated at a location corresponding to the right eye in order to output an image toward the user's right eye.

The display unit 451 may project an image into the user's eye using a prism. And, the prism may be formed to be optically transparent so that the user can watch the projected image and a general visual field (i.e., a range viewed by a user through the corresponding eye) in front of the user.

Thus, the image outputted through the display unit 451 may be viewed in a manner of overlapping the general visual field. The mobile terminal 400 can provide AR (Augmented Reality) by overlaying a virtual image on a real image or a background using the property of the display.

The camera 421 may be disposed adjacent to at least one of the left eye and the right eye to photograph an image in front. Since the camera 421 is situated adjacent to the eye, the camera 421 can obtain an image of a scene currently viewed by the user.

According to the example shown in the preset drawing, the camera 421 is provided to the control module 480, by which the present invention is non-limited. Alternatively, the camera 421 may be installed in the frame unit. Alternatively, a plurality of cameras may be provided to obtain stereoscopic images.

The glass type mobile terminal 400 may include user input units 423a and 423b manipulated to receive an input of a control command. The user input units 423a and 423b may employ any manners (e.g., touch, push, etc.) corresponding to a tactile manner in which a user can perform manipulations by experiencing a tactile sense. According to the example shown in the present drawing, the user input units 423a and 423b of the push input manner and the touch input manner are provided to the frame unit and the control module 480, respectively.

Moreover, the mobile terminal 400 may further include a microphone (not shown in the drawing) for receiving an input of a sound and then processing the input sound into electric audio data and an audio output module 452 for outputting audio. The audio output module 452 may be configured to transfer audio in a general audio output manner or an osteoconductive manner. In case that the audio output unit 452 is embodied in the osteoconductive manner, when the user wears the mobile terminal 400, the audio output unit 452 comes in close contact with a user's head and vibrates user's skull to transfer audio.

A communication system that can be embodied through the mobile terminal 100 according to the present invention is described in detail as follows.

First of all, a communication system may be configured to utilize any of a variety of different air interfaces and/or physical layers. Examples of such air interfaces utilized by the communication system include Frequency Division Multiple Access (FDMA), Time Division Multiple Access (TDMA), Code Division Multiple Access (CDMA), Universal Mobile Telecommunications System (UMTS) (including, Long Term Evolution (LTE), LTE-A(Long Term Evolution-Advanced)), Global System for Mobile Communications (GSM), and the like.

For clarity, the following description is limited to CDMA only. Yet, it is apparent that the present invention applies equally to other system types including not only CDMA wireless communication system but also OFDM (Orthogonal Frequency Division Multiplexing) wireless communication system.

The CDMA wireless communication system generally includes at least one terminal 100, at least one base station (BS) (possibly named Node B or Evolved Node B), at least one or more base station controllers (BSCs), and a mobile switching center (MSC). The MSC is configured to be connected to a conventional Public Switched Telephone Network (PSTN) and the BSCs. The BSCs are coupled to the base stations to pair with via backhaul line. The backhaul line may be provided in accordance with at least one of E1/T1, ATM, IP, PPP, Frame Relay, HDSL, ADSL, and xDSL. Hence, a plurality of BSCs can be included in the CDMA wireless communication system.

Each of a plurality of BSs (base stations) may include at least one or more sectors. And, each of the sectors may include an omni-directional antenna or an antenna indicating a specific direction radially away from the BS. Alternatively, each of the sectors may include two or more antennas of various types. Each of the BSs may be configured to support a plurality of frequency assignments. And, each of a plurality of the frequency assignments may have a specific spectrum (e.g., 1.25 MHz, 5 MHz, etc.).

The intersection of sector and frequency assignment may be referred to as a CDMA channel. The base stations may also be referred to as Base Station Transceiver Subsystems (BTSs). In this case, the term “base station” may be used to refer collectively to one BSC and at least one BS. The base stations may indicate “cell site.” Moreover, each of a plurality of sectors for a specific BS may be referred to as a plurality of cell sites.

A broadcasting transmitter (BT) transmits a broadcast signal to the mobile terminals 100 operating within the system. The broadcast receiving module 111 shown in FIG. 1A is typically configured inside the mobile terminal 100 to receive broadcast signals transmitted by the BT.

Moreover, Global Positioning System (GPS) for locating the position of the mobile terminal 100 may cooperate with the CDMA wireless communication system. The satellite 300 helps to obtain a location of the mobile terminal 100. Useful position information may be obtained with greater or fewer satellites than two. In doing so, it is able to trace a location of the mobile terminal 100 using all technologies capable of tracing locations or positions as well as the GPS tracking technology. If desired, at least one of the GPS satellites may be in charge of satellite DMB transmissions optionally or additionally.

The location information module 115 provided to the mobile terminal is generally configured to detect, calculate, or otherwise identify a position or location of the mobile terminal. As a representative example, the location information module 115 may include a Global Position System (GPS) module, a Wi-Fi (wireless fidelity) module, or both. If desired, the location information module 115 may alternatively or additionally function as any of the other modules of the wireless communication unit 110 to obtain data related to the position or location of the mobile terminal.

The GPS module 115 accurately calculates current 3D location information according to latitude, longitude and latitude by measuring an accurate time and distance from three or more satellites and then applying trigonometry to the calculated informations. Currently, a method of acquiring distance and time information from three satellites and performing error correction with a single satellite is popularly used. Moreover, the GPS module 115 can acquire speed information by continuing to calculate a real-time current location. Yet, accuracy of a measured location or position of the mobile terminal may be compromised when the mobile terminal is located in such a blind spot of satellite signals as an indoor space or the like. In order to compensate the measured location by GPS system, it is able to use Wi-Fi Positioning System (WPS) and the like.

The Wi-Fi positioning system (WPS) is the location determination technology based on a wireless local area network (WLAN) using Wi-Fi as a technology for tracking the location of the mobile terminal 100. This technology typically includes the use of a Wi-Fi module in the mobile terminal 100 and a wireless access point for communicating with the Wi-Fi module.

The Wi-Fi positioning system may include a Wi-Fi location determination server, a mobile terminal 100, a wireless access point (AP) connected to the mobile terminal 100, and a database storing random wireless AP information.

The mobile terminal 100 currently connected to the wireless AP may send a location information request message to the Wi-Fi location determination server.

The Wi-Fi location determination server extracts the information of the wireless AP connected to the mobile terminal 100, based on the location information request message (or signal) of the mobile terminal 100. The information of the wireless AP connected to the mobile terminal 100 may be sent to the Wi-Fi location determination server through the mobile terminal 100, or sent to the Wi-Fi location determination server from the wireless AP.

The information of the wireless AP extracted based on the location information request message of the mobile terminal 100 may include at least one of media access control (MAC) address, service set identification (SSID), received signal strength indicator (RSSI), reference signal received Power(RSRP), reference signal received quality(RSRQ), channel information, privacy, network type, signal strength, noise strength, and the like.

As mentioned in the above description, the Wi-Fi location determination server receives the information of the wireless AP connected to the mobile terminal 100 and may be then able to extract wireless AP information corresponding to the wireless AP connected to the mobile terminal from the pre-established database. In this case, the information of any wireless APs stored in the database may include information such as MAC address, SSID. RSSI, channel information, privacy, network type, latitude and longitude coordinate, building at which the wireless AP is located, floor number, detailed indoor location information (GPS coordinates available), AP owner's address, phone number, and the like. In doing so, in order to remove a mobile AP or a wireless AP provided using an illegal MAC address in the course of a location determining process, the Wi-Fi location determination server may extract only a prescribed number of wireless AP informations in order of high RSSI.

Thereafter, the Wi-Fi location determination server may extract (analyze) location information of the mobile terminal 100 using at least one wireless AP information extracted from the database. By comparing the included information and the received wireless AP information to each other, the location information of the mobile terminal 100 is extracted (or analyzed).

As a method for extracting (or analyzing) the location information of the mobile terminal 100, it is able to utilize a Cell-ID scheme, a fingerprint scheme, a trigonometry scheme, a landmark scheme and the like.

The Cell-ID scheme is used to determine a location of a wireless AP having the largest signal strength among peripheral wireless AP informations collected by a mobile terminal as a location of the mobile terminal. The Cell-ID scheme has advantages as follows. First of app, Implementation of the Cell-ID scheme is minimally complicated. Secondly, the Cell-ID scheme does not require additional costs. Thirdly, location information can be rapidly acquired. Yet, the Cell-ID scheme has the disadvantage in that the precision of positioning may fall below a desired threshold when the installation density of wireless APs is low.

The fingerprint scheme is a method of estimating a location through a signal strength information transmitted by a mobile terminal based on information collected by selecting a reference location from a service area. In order to use the fingerprint scheme, it is necessary to establish database of propagation characteristics in advance.

The trigonometry scheme is used to calculate a location of a mobile terminal based on a distance between coordinates of at least three wireless APs and the mobile terminal. In order to measure the distances between the mobile terminal and the wireless APs, signal strength may be converted into distance information, or Time of Arrival (ToA). Time Difference of Arrival (TDoA), Angle of Arrival (AoA) and the like may be used.

The landmark scheme is used to measure a location or position of a mobile terminal using a known landmark transmitter.

In addition to the above-listed schemes, various algorithms may be used to extract (or analyze) location information of a mobile terminal.

Such extracted location information may be transmitted to the mobile terminal 100 through the Wi-Fi location determination server, whereby the mobile terminal can acquire the location information.

The mobile terminal 100 can acquire location information by being connected to at least one wireless AP. In doing so, the number of wireless APs required for acquiring the location information of the mobile terminal 100 may be variously changeable depending on a wireless communication environment in which the mobile terminal 100 is situated.

As mentioned in the foregoing description with reference to FIG. 1A, short-range communication techniques such as Bluetooth™, Radio Frequency Identification (RFID), Infrared Data Association (IrDA), Ultra Wideband (UWB), ZigBee, Near Field Communication (NFC), Wireless USB(Wireless Universal Serial Bus) and the like may apply to the mobile terminal according to the present invention.

Among the short-range communication technologies, NFC module provided to the mobile terminal supports an inter-terminal non-contact type short-range wireless communication in a distance of about 10 cm range. The NFC module may operate in one of a card mode, a reader mode and a P2P mode. The mobile terminal 100 may further include a security module for storing card information in order to for the NFC module in the card mode. In this case, the security module may include one of a physical medium such as Universal Integrated Circuit Card (UICC) (e.g., Subscriber Identification Module (SIM), Universal SIM (USIM), etc.), Secure micro SD, a sticker and the like, or a logical medium (e.g., embedded Secure Element (SE), etc.) embedded in the mobile terminal. Data exchange may be performed between the NFC module and the security module based on Single Wire Protocol (SWP).

In a case that the NFC module operates in the card mode, the mobile terminal may externally transfer card information saved like a traditional 1C card. In particular, if a mobile terminal storing card information of a payment card (e.g., a credit card, a bus card, etc.) approaches a card reader, a short-range mobile payment may be processed. If a mobile terminal storing card information of an entrance card approaches an entrance card reader, an entrance approval procedure may start. A card such as a credit card, a traffic card, or an entrance card may be loaded on the security module in the form of applet, and the security module may store card information on the loaded card. In this case, the card information of the payment card may include at least one of a card number, a remaining amount, a use history, and the like. The card information of the entrance card may include at least one of a user's name, a user's number (e.g., a user's student number, a user's staff number, etc.), an entrance history, and the like.

In case that the NFC module operates in the reader mode, the mobile terminal can read data from an external tag. In doing so, the data received from the external tag by the mobile terminal may be coded in NFC Data Exchange Format defined by NFC Forum. And, the NFC Forum generally defines four record types. In particular, the NFC Forum defines four Record Type Definitions (RTDs) such as Smart Poster, Text, Uniform Resource Identifier (URI), General Control and the like. If the data received from the external tag is a smart poster type, the controller can run a browser (e.g., Internet browser, etc.). If the data received from the external tag is a text type, the controller can run a text viewer. If the data received from the external tag is a URI type, the controller can run a browser or make a phone call. If the data received from the external tag is a general control type, the controller can execute an accurate operation in accordance with control contents.

In case that the NFC module operates in the P2P (Peer-to-Peer) mode, the mobile terminal can perform P2P communication with another mobile terminal. In this case, Logical Link Control Protocol (LLCP) can apply to the P2P communication. For the P2P communication, connection may be created between one mobile terminal and another mobile terminal. In this case, the connection may be categorized into a connectionless mode terminated after switching a single packet or a connection-oriented mode for exchanging packets consecutively. Through the P2P communication, data such as an electronic type business card, contact information, a digital photo, a URL and the like, setup parameters for Bluetooth connection, Wi-Fi connection, etc. can be exchanged. Yet, the P2P mode can be effectively utilized in exchanging data in small size because an available distance for the NFC communication is relatively short.

Hereinafter, embodiments related to a control method that can be implemented in the above-configured mobile terminal shall be described with reference to the accompanying drawings. It will be appreciated by those skilled in the art that various modifications and variations can be made in the present invention without departing from the spirit or scope of the inventions.

In the following, a method of performing a high-quality audio recording based on an audio preset determined on the basis of a sound sensed through a plurality of microphones provided to a mobile terminal shall be described with reference to FIGS. 5 to 27.

FIG. 5 is a block diagram showing configuration modules of a mobile terminal according to one embodiment of the present invention.

Referring to FIG. 5, a mobile terminal according to one embodiment of the present invention may include a display unit 510, a voice recognition unit 520, a user input unit 530, a camera 540, a location information sensing unit 550, a memory 560 and a controller 570. In addition, various configuration modules may be further included as well as the above configuration modules.

First of all, the display unit 510 may output visual information. Here, the visual information may include a content, an application, an image, a video, an icon, a user interface and the like. The display unit 610 may output visual information to a screen based on a control command of the controller 570. According to the present invention, the display unit 510 may be implemented with the display 151 shown in FIG. 1A.

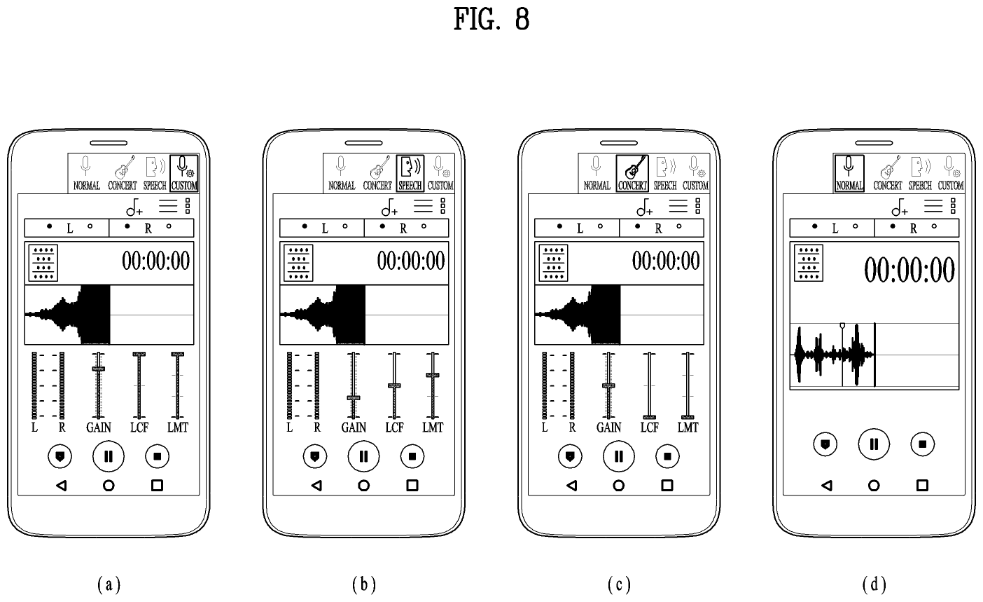

In the present invention, the display unit 510 may be implemented in form of a touchscreen in a manner of being combined with the user input unit 530. According to one embodiment of the present invention, if an audio recording application is launched, a display unit can output a single interface among a plurality of audio presets including a plurality of parameters. A plurality of the audio presets shall be described in detail with reference to FIG. 8 later.

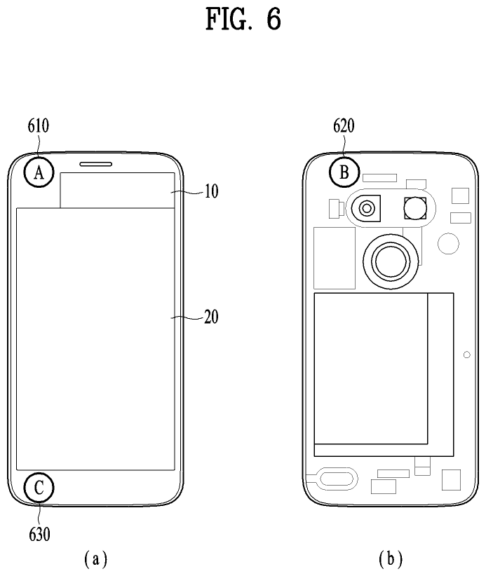

The voice recognition unit 520 may sense an audio signal. Particularly, the voice recognition unit 520 can sense various audio signals sensed within a location range of a preset distance of the mobile terminal. In the present invention, the voice recognition unit 520 may be implemented with the microphone 122 shown in FIG. 1A. According to one embodiment of the present invention, the voice recognition unit 520 may include two or more microphones, which shall be described in detail with reference to FIG. 6.

The user input unit 530 may sense various input received from a user. For example, the user input unit 530 may sense a direct touch input, a proximity touch input and the like. In the present invention, the user input unit 530 may be implemented with the user input unit 123 shown in FIG. 1A. According to one embodiment of the present invention, while various options related to an audio preset are outputted to the display unit 510, the user input unit 530 can sense a user's touch input.

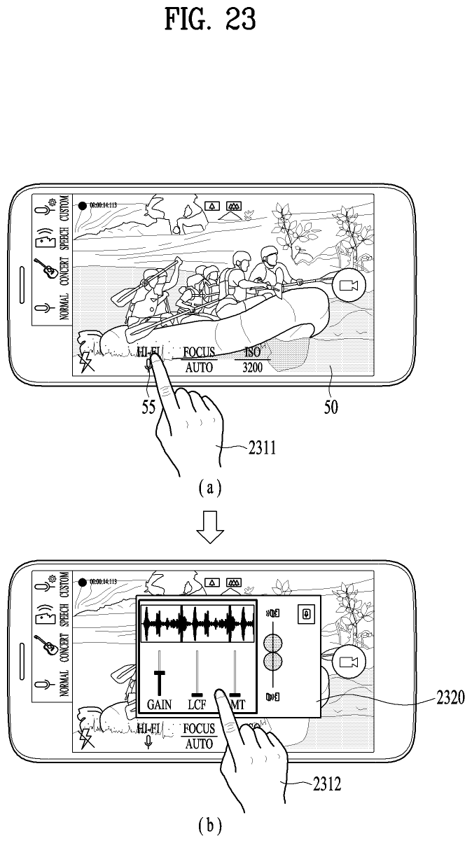

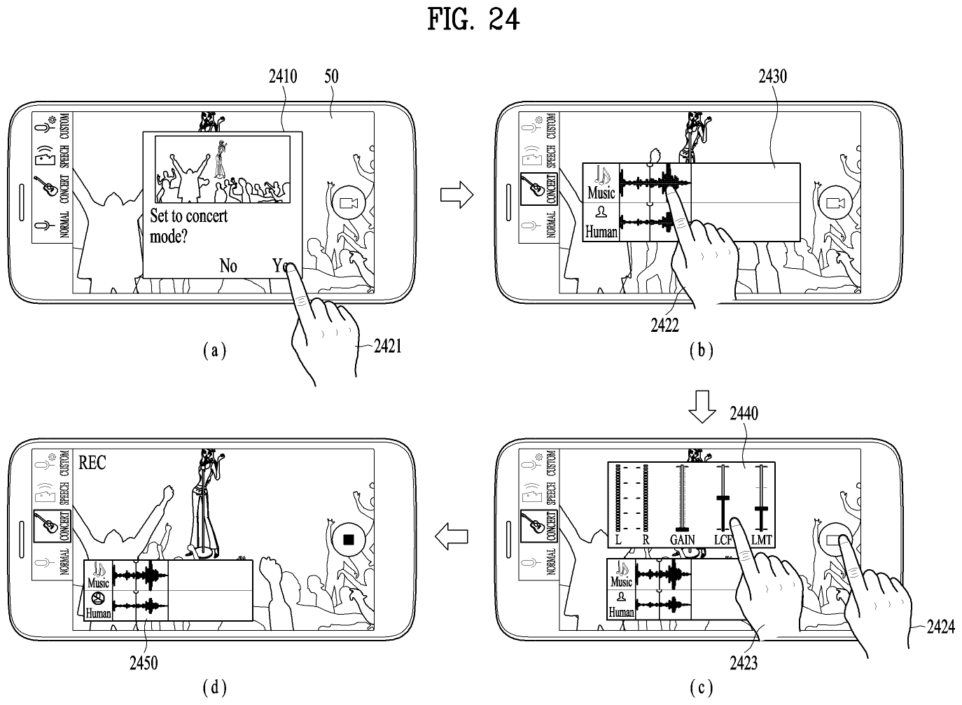

The camera can sense an object or subject within a view angle range. In the present invention, the camera 540 may be implemented with the camera 12a shown in FIG. 1A. According to one embodiment of the present invention, the camera 540 can sense a still image or a video, which shall be described with reference to FIGS. 23 to 26.

The location information sensing unit 550 may sense information on a place at which the mobile terminal is located. For example, the location information sensing unit 550 can sense location information through a GPS. In the present invention, the location information sensing unit 550 may be implemented with the location information module 115 shown in FIG. 1A. According to one embodiment of the present invention, the location information sensing unit 550 can obtain information on a place at which the mobile terminal is currently located and then forward it to the controller 570.

The memory 560 may store data related to operations performed in the mobile terminal For example, the memory 560 may include a storage medium outside the mobile terminal as well as a storage medium provided to the mobile terminal. In the present invention, the memory 560 may be implemented with the memory 170 shown in FIG. 1A. According to one embodiment of the present invention, the memory 560 can store an audio data file recorded through an audio recording application and/or a video data recorded through a video recording application.

The controller 570 can process data, control the respective units of the above-described mobile terminal, and control data transmissions/receptions between the units. In the present invention, the controller 570 may be implemented with the controller 180 shown in FIG. 1A. According to one embodiment of the present invention, if an audio recording application is launched, the controller 570 can provide one of a plurality of presets including a plurality of parameters.

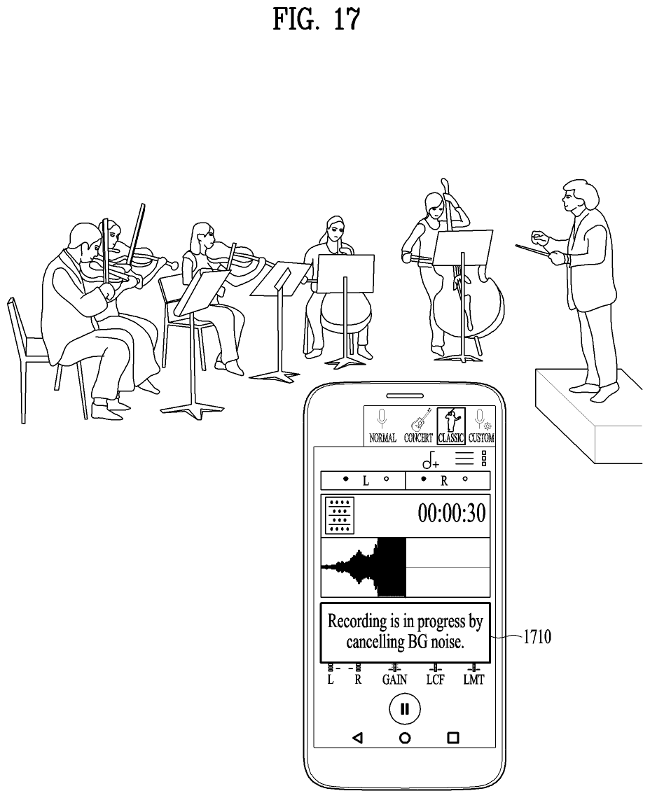

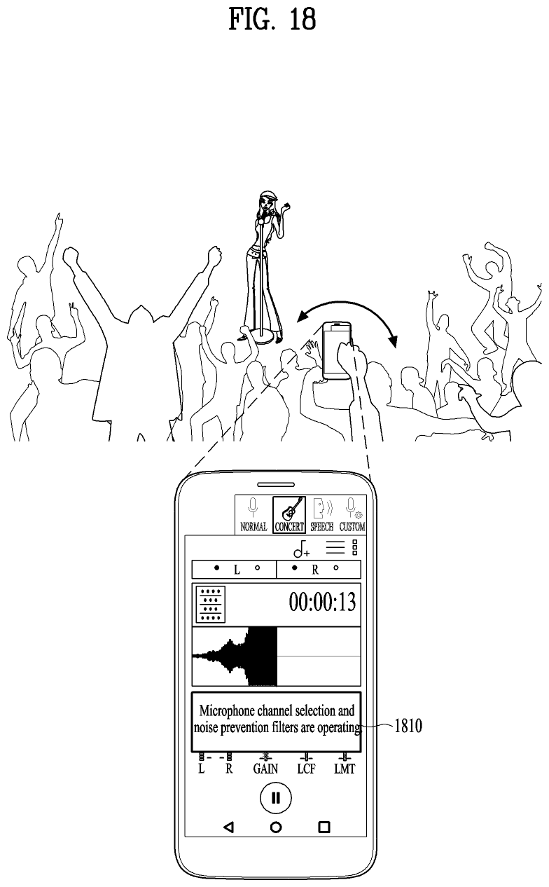

The mobile terminal may additionally include a motion information sensing unit, which is not shown in FIG. 5. The motion information sensing unit (not shown) may sense a user's motion using a gyro sensor and an acceleration sensor and forward a sensing result to the controller 570. The motion information sensing unit (not shown) shall be described in addition with reference to FIG. 17 and FIG. 18.

According to one embodiment of the present invention, operations performed by the mobile terminal can be controlled by the controller 570. For clarity, such operations shall be commonly described as performed/controlled by the mobile terminal in the drawings and the following description. Through the embodiments shown in FIGS. 6 to 27, in case of performing an audio recording function in a mobile terminal, a method of providing various presets according to a situation shall be described as follows.

FIG. 6 is a diagram showing one example of a plurality of microphones provided to a mobile terminal according to one embodiment of the present invention.

For further precise sound recognition, a mobile terminal may be provided with a plurality of microphones instead of a single microphone. Moreover, in case that a plurality of microphones are provided to a single terminal, a region for sensing audio in a mobile terminal may differ per microphone. Namely, a microphone provided to a mobile terminal of the present invention may correspond to a directional microphone capable of selectively sensing audio heard in a specific direction. For example, a microphone located on the left side of a mobile terminal may mainly sense audio generated from a left area of the mobile terminal, while a microphone located on the right side of the mobile terminal may mainly sense audio generated from a right area of the mobile terminal.

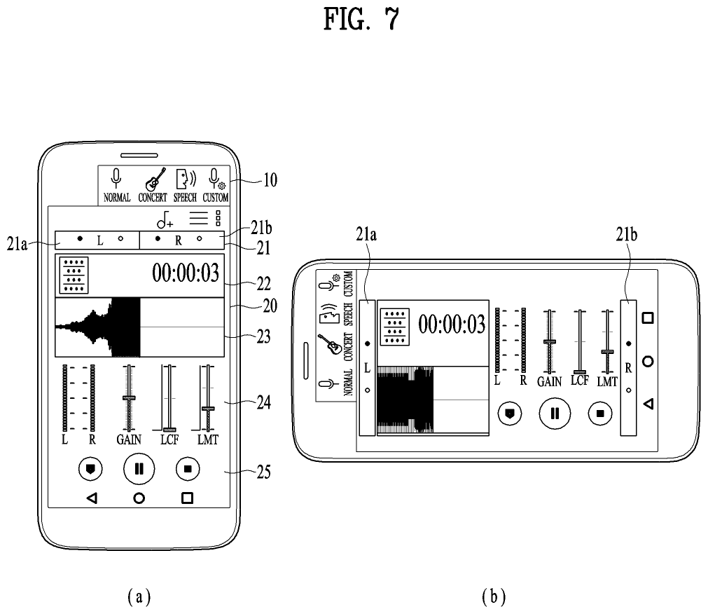

In some implementations, according to one embodiment of the present invention, a mobile terminal may include 3 microphones that are the directional microphones. Regarding this, referring to FIG. 6 (a) and FIG. 6 (b), a first microphone 610 may be located at a left top end of a front part with reference to a state that the front part of the mobile terminal faces the front. Particularly, the first microphone 610 may be disposed in a region except a first display region 10 and a second display region 20 disposed side by side on the front part. Here, the front part of the mobile terminal may correspond to a face on which a display unit is disposed. The first and second display regions 10 and 20 shall be described again with reference to FIG. 7 later.

Referring to FIG. 6 (b), a second microphone 620 may be located at a right top end of a rear part with reference to a state that the front part of the mobile terminal faces the front. Namely, the second microphone 620 may be located on a left top end of the rear part while the front part of the mobile terminal faces the rear. Referring to FIG. 6 (a), a third microphone 630 may be located at a left bottom end of the front part with reference to a state that the front part of the mobile terminal faces the front. Particularly, the third microphone 630 may be disposed in a region except the first display region 10 and the second display region 20 disposed side by side on the front part. Namely, as described above, the first to third microphones 610, 620 and 630 are disposed in different regions, thereby sensing audios sensed in various directions precisely. In this case, a mainly used microphone may vary depending on a portrait or landscape mode of the mobile terminal. For example, audio can be sensed through the first and second microphones 610 and 620 in the portrait mode, or through a combination of the first and third microphones 610 and 630 or a combination of the second and third microphones 620 and 630 in the landscape mode. In doing so, the remaining microphone failing to sense audio may be controlled to enter a mute mode or have a gain lowered. For example, the mobile terminal can recognize 8 directions in which sounds are generated through combinations of a plurality of directional microphones, by which the present invention is non-limited.

Meanwhile, although one embodiment of the present invention assumes that a mobile terminal includes 3 directional microphones, it is obvious that the present invention is applicable to a case that the mobile terminal includes a plurality of microphones without being limited by such assumption.

FIG. 7 is a diagram showing one example of a running screen of an audio recording application of a mobile terminal according to one embodiment of the present invention.

First of all, a display unit of the present invention may be divided into 2 display regions, i.e., a first display region 10 and a second display region 20, disposed side by side in a first direction. The mobile terminal may independently control each of the two display regions. In the present invention, the first display region 10 and the second display region 20 may correspond to a sub display region and a main display region, respectively.

For example, the second display region 20 may correspond to a region for outputting general image information and the first display region 10 may correspond to a region for outputting a status bar indicating statuses of the mobile terminal. For another example, the second display region 20 may correspond to a region for outputting a running screen of an application and the first display region 10 may correspond to a region for outputting a control screen of an application running in the second display region 20.

Meanwhile, as shown in FIG. 7, the first display region 10 may have at least one of a width and height smaller than that of the second display region 20. The first display region 10 may be disposed on one side of the second display region 20. The first display region 10 may have a rectangular shape in a size smaller than that of the second display region 20.

In case of running an audio recording application, the mobile terminal can output a running screen to the display unit. Regarding this, in the first display region 10, icons indicating a plurality of audio presets can be outputted as a status bar of the audio recording application. Moreover, a currently outputted audio preset can be highlighted in a manner of differentiating a graphic effect.

The second display region 20 corresponds to a region for outputting an interface of an audio preset. The interface of the audio preset may include a microphone indicator region 21, a recording time region 22, a waveform region 23, a parameter region 24 and a recording control region 25. The microphone indicator region 21 can indicate a presence or non-presence of audio sensing of a currently activated microphone among a plurality of microphones provided to the mobile terminal. For example, as described in FIG. 6, the mobile terminal can activate two microphones among three microphones and use the activated microphones mainly. In case of a left-located one of the two microphones, a state is indicated in a left microphone region 21a. In case of a right-located one of the two microphones, a state is indicated in a right microphone region 21a.

The recording time region 22 may indicate a current recording progress time. The waveform region 23 may output a waveform timeline indicating a change of a size (dB) according to a time change of sound sensed through a microphone. In the present invention, it is assumed that the waveform region 23 can output a waveform according to a size change of a sensed sound even before performing an audio recording.

The parameter region 24 may include a gain parameter, a Low Cut Filter (LCF) parameter, and a Limiter (LMT) parameter. The gain parameter is the parameter for adjusting sensitivity of a microphone. If a gain value is raised, a small sound can be recorded sensitively. The LCF parameter corresponds to a parameter for eliminating noise by eliminating a sound of a low range. The LMT parameter corresponds to a parameter for recording uniform audio by eliminating a pop sound in a high-range sound. Meanwhile, based on different setup values of the gain parameter, the LCF parameter and the limiter parameter, the mobile terminal can provide a plurality of various audio presets according to situations, which shall be described with reference to FIG. 8. Moreover, the parameter region 24 may include a parameter indicating a size of audio sensed from each of the left microphone region 21a and the right microphone region 21b. The recording control region 25 may include buttons for start, stop and pause of an audio recording.

Meanwhile, the disposition of regions outputted to the second display region 20 may vary according to a portrait or landscape mode of the mobile terminal. For example, in case of the portrait mode in FIG. 7 (a), the microphone indicator region 21 is located at a top end. In case of the landscape mode in FIG. 7 (b), the microphone indicator region 21 can be disposed as a left microphone region 21a and a right microphone region 21b located on a left side and a right side, respectively.

FIG. 8 is a diagram showing one example of a plurality of audio presets provided in a mobile terminal according to one embodiment of the present invention.

According to a setting of a mobile terminal or a situation, an audio recording application can provide various audio presets. In each of the audio presets, values of the aforementioned gain, LCF and limiter parameters may be provided differently. According to each audio preset, an icon corresponding to the audio preset can be displayed in a first display region by being highlighted. According to one embodiment of the present invention, a mobile terminal can provide a basic preset, a concert preset, a speech preset and a manual preset, by which the present invention is non-limited.

Particularly, FIG. 8 (a) shows an interface of a speech preset, corresponding to a preset optimized for conference and lecture recordings. FIG. 8 (b) shows an interface of a manual preset, in which a user can set each parameter value manually. FIG. 8 (c) shows an interface of a concert preset, corresponding to a preset optimized for a concert and performance recordings. FIG. 8 (d) shows an interface of a basic preset, corresponding to a preset for facilitating a recording without separate settings. Moreover, a conference preset, an interview preset, a classic preset and the like may be included as audio presets as well [not shown in FIG. 8].

According to one embodiment of the present invention, in case of running an audio recording application, a mobile terminal can provide the basic preset shown in FIG. 8 (d). If audio is sensed before starting a recording, the mobile terminal can provide a popup for selecting to recommend one of the presets shown in FIGS. 8 (a) to 8 (c) to a user based on the sensed audio. Yet, if audio is not sensed before starting a recording, the mobile terminal may progress a recording using the basic preset.

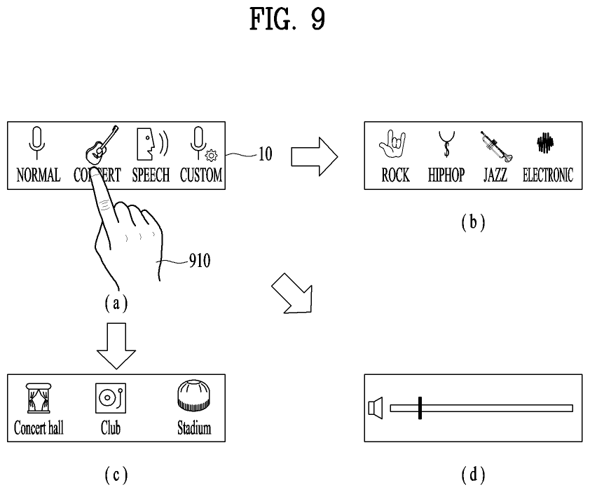

FIG. 9 is a diagram showing one example of utilizing a first display region of a mobile terminal according to one embodiment of the present invention.

In particular, FIG. 9 shows a case of setting a subcategory of an audio preset using a first display region. Moreover, an embodiment shown in FIG. 9 assumes a case that a first display region 10 of a display unit is enlarged and illustrated.

As described with reference to FIG. 7, in the first display region 10, icons indicating a plurality of audio presets can be outputted as a status bar of an audio recording application. In case of running the audio recording application, as shown in FIG. 9 (a), the mobile terminal can output icons indicating a basic preset, a concert preset, a speech preset and a manual preset.

In doing so, the mobile terminal may sense an input signal 910 for selecting the concert preset. For example, the input signal 910 corresponds to a single tap input. Through this, the mobile terminal can determine an initial preset as a concert preset. In this case, the mobile terminal may set an audio recording in a second display region (not shown) according to the concert preset and output a concert preset interface [not shown in FIG. 9].

In some implementations, in response to the input signal 910, the mobile terminal can output various selectable subcategories. For example, referring to FIG. 9 (b), the mobile terminal can output a subcategory of the concert preset to the first display region 10. For one example, the subcategory may include genres such as rock, hip-hop, jazz, electronic, etc. For another example, referring to FIG. 9 (c), the mobile terminal may output an environment condition for holding a convert to the first display region 10. For example, the environment condition may include a concert hall, a club and a stadium. For further example, referring to FIG. 9 (d), the mobile terminal may output a volume indicator of the convert preset to the first display region 10.

In some implementations, the subcategory of the audio preset is non-limited by the above description. And, various subcategories may be outputted according to a configuration of the mobile terminal or a user's configuration. Moreover, through the detailed category configuration on the first display region 10, it is able to provide a quick setting optimized for a user.

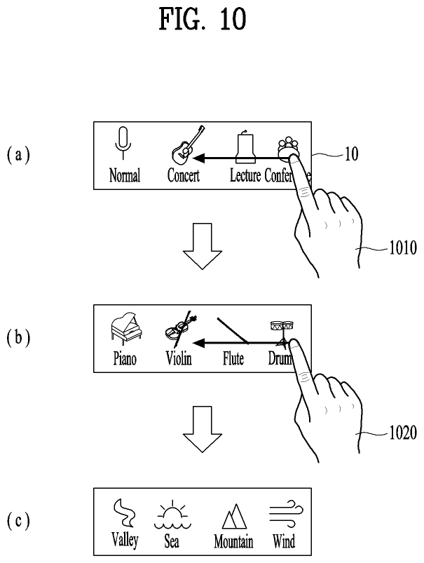

FIG. 10 is a diagram showing one example of utilizing a first display region of a mobile terminal according to one embodiment of the present invention.

In particular, FIG. 10 shows a method of providing various preset sets of an audio preset using a first display region. Unlike FIG. 9, the embodiment of FIG. 10 shows a case of sensing a flicking or drag touch as an input signal. And, the embodiment of FIG. 10 is assumed as a case that a first display region 10 of a display unit is described by being enlarged only.

First of all, in case of running an audio recording application, as shown in FIG. 10 (a), a mobile terminal can output icons indicating a basic preset, a concert preset, a speech preset and a manual preset. The 4 presets are assumed as corresponding to default presets.

In doing so, the mobile terminal may sense a first input signal 1010 applied to the first display region 10. For example, the first input signal 1010 may correspond to a flicking or drag touch in one direction.

In this case, in response to the first input signal 1010, the mobile terminal may output an icon corresponding to an audio preset of another type instead of the default preset. For example, as shown in FIG. 10 (b), the mobile terminal can control icons, which correspond instrument play presets such as a piano preset, a violin preset, a flute preset and a drum preset, to be outputted to the first display region 10.

The mobile terminal may sense a second input signal 1020 applied to the first display region 10. For example, the second input signal 1020 may correspond to an input of the same type of the first input signal 1010. In response to the second input signal 1020, the mobile terminal may output an icon corresponding to an audio preset of another type instead of the default preset. For example, as shown in FIG. 10 (c), the mobile terminal can control icons, which correspond to nature sound presets such as a valley preset, a sea preset, a mountain preset and a wind preset, to be outputted to the first display region 10.

Through this, a user may designate various sets of presets in the mobile terminal and then perform an audio recording by selecting an audio preset optimized for a situation. Moreover, the case of the above-described presets just shows one example, by which the present invention is non-limited obviously. Meanwhile, if a user selects a desired preset from a plurality of the presets outputted to the first display region 10, the mobile terminal may perform an audio recording by adjusting a plurality of parameter values according to the selected preset.

Moreover, in case that a surrounding sound increases or decrease rapidly, the mobile terminal may stop outputting an icon corresponding to an audio preset and output a volume indicator for adjusting a master volume to the first display region 10 [not shown in FIG. 10].

Audio Preset Settings According to User Selection

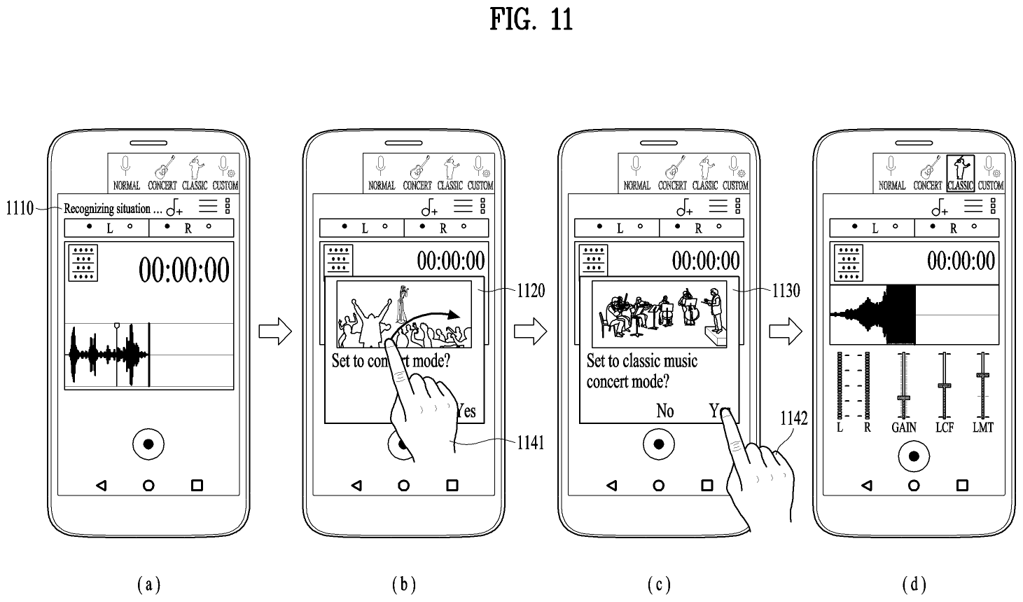

FIG. 11 is a diagram showing one example of recognizing a recording situation in a mobile terminal according to one embodiment of the present invention.

Referring to FIG. 11 (a), in case of running an audio recording application, a mobile terminal may output an interface of a basic preset. Here, the basic preset indicates an audio preset capable of facilitating a recording without the separate settings described in FIG. 8 (d).

If the audio recording application is run, the mobile terminal may activate at least some of a plurality of microphones provided to the mobile terminal. Through this, the mobile terminal analyzes audio generated from surroundings and then determines current circumstances. Moreover, the mobile terminal outputs a situation indicator 1110, thereby indicating that situation recognition is in progress owing to an activated microphone of the mobile terminal. Subsequently, while a voice recording does not start, the mobile terminal can recognize the current circumstances.

In doing so, based on the audio sensed through the microphone, the mobile terminal may determine an audio preset suitable for a current state. For example, the mobile terminal can determine a current situation based on the weight of the audio sensed through a plurality of microphones. For example, if voices of several persons are evenly sensed through first to third microphones, the mobile terminal can determine a state of a conference in progress. Moreover, for example, if a specific person's voice is mainly sensed through the first and second microphones, the mobile terminal can determine a state of a speech in progress. For example, if voices are sensed alternately through the first (or second) microphone and the third microphones, the mobile terminal can determine a state of an interview in progress.

For another example, based on the reverberation of sound, the mobile terminal can determine a current situation. For example, if the reverberation of the sensed sound is relatively big, the mobile terminal can determine an indoor place such as a concert hall. For example, if the reverberation of sound is relatively small, the mobile terminal can determine an open outdoor place.

Moreover, as shown in FIG. 11 (b), the mobile terminal may output a recommended audio preset popup 1120 to the display unit. The recommended audio preset popup 1120 may indicate an audio preset proposed on the basis of a current surrounding state through an activated microphone. In the example of FIG. 11, the mobile terminal may propose a concert preset.

In doing so, if a user determines that a concert preset is appropriate, an input signal may be applied to ‘Yes’ in the recommended audio preset popup 1120. In this case, the mobile terminal can output the concert preset to the display unit and configure an audio recording according to the concert preset. On the other hand, if a user determines that a concert preset is not appropriate and intends to progress a recording using a basic preset without an audio preset, an input signal may be applied to ‘No’ in the recommended audio preset popup 1120.

Yet, if a user determines that a concert preset is not appropriate and intends to search for another preset, a flicking or drag input signal 1141 may be applied in one direction to the recommended audio preset popup 1120. In this case, as shown in FIG. 11 (c), the mobile terminal may output a classic music concert preset 1130 to a current status popup instead of a concert preset. Moreover, if an input signal from the user is applied to ‘Yes’ in a recommended audio preset popup 1130 to which the classic music concert preset is outputted, as shown in FIG. 11 (d), the mobile terminal can control an interface of the classic music concert preset to be outputted to the display unit.

Moreover, while the interface of the classic music concert preset is outputted, if an input signal for an audio recording is sensed, the mobile terminal may progress the audio recording ill a state that a parameter for recording the classic music concert optimally is set [not shown in FIG. 11]. Moreover, as shown ill FIG. 11 (d), the mobile terminal highlights an icon of ‘classic music concert’ in the first display region 10, thereby indicating that the classic music concert is outputted.

In some implementations, if a flicking or drag touch input for searching for an audio preset other than the classic music concert preset is additionally sensed from a user, the mobile terminal may output an additional audio preset to a current status popup. Moreover, in case of the embodiment of FIG. 11, the mobile terminal is in portrait mode and may correspond to the aforementioned state that the first and second microphones are activated in FIG. 6.

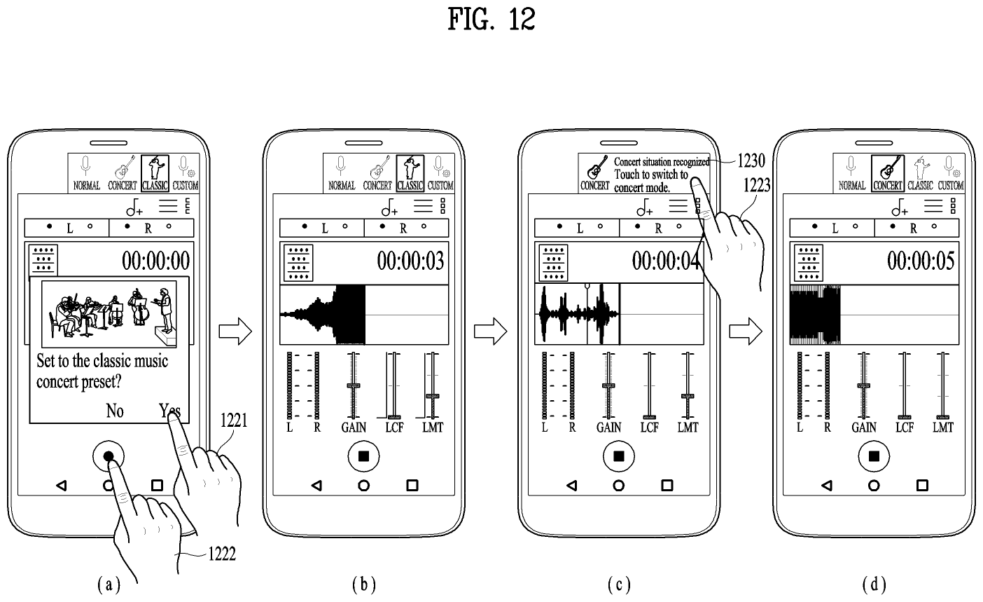

FIG. 12 is a diagram showing another example of recognizing a recording situation in a mobile terminal according to one embodiment of the present invention.

The embodiment of FIG. 12 relates to a case that an audio preset is changed in case of recognizing a different situation in the course of progressing a recording in an audio preset configured state. In the embodiment of FIG. 12, while an audio recording application is running, a mobile terminal is assumed as determining that a surrounding environment sensed through an activated microphone is a classic music concert. The contents redundant with those of the embodiment of FIG. 11 shall be omitted from the description of the embodiment of FIG. 12.

Referring to FIG. 12 (a), a mobile terminal may output a current status popup 1210 corresponding to a classic music concert preset. Here, the current status popup 1210 may correspond to the recommended audio preset popup described in FIG. 11. If sensing a first input signal 1221 for selecting the current status popup, the mobile terminal may output an interface of the classic music concert preset to a display unit. Moreover, if sensing the first input signal 1221, the mobile terminal may highlight and display an icon corresponding to a classic music concert to a first display region 10. If sensing a second input signal 1222 for selecting a recording menu, as shown in FIG. 12 (a), the mobile terminal may start an audio recording. In this case, as shown in FIG. 12 (b), the mobile terminal may progress a recording in a state of being set to the classic music concert preset.

Meanwhile, while the audio recording is in progress in the state of being set to the classic music concert preset, the mobile terminal may recognize that a currently sensed audio corresponds to a concert situation. In this case, as shown in FIG. 12 (c), the mobile terminal may output a situation change indicator 1230 to the first display region 10. The situation change indicator 1230 may correspond to an indicator indicating that a previously configured audio preset is not suitable for a current situation and also proposing or recommending an audio preset corresponding to a new environment. For example, in the example of FIG. 12, it may correspond to a case that the mobile terminal recognizes a concert situation while applying the classic music concert preset.

Furthermore, if sensing a third input signal 1223 applied to the situation change indicator 1230, the mobile terminal may output an interface of a concert preset to the display unit. Here, the third input signal 1223 corresponds to a signal for applying the changed concert preset. The mobile terminal may highlight and display an icon corresponding to the concert on the first display region 10, output the interface of the concert preset to a second display region 20, and set a recording situation to a concert.

The above-described embodiment of FIG. 12 is usable for a case of recognizing that a new situation occurs while a recording is in progress. For example, the new situation may correspond to a case that a sound volume changes abruptly, a case that a talk time is in progress in the course of a classic music concert, etc. Moreover, it is a matter of course that the embodiment of FIG. 12 is applicable to a case that a new situation occurs before progressing an audio recording.

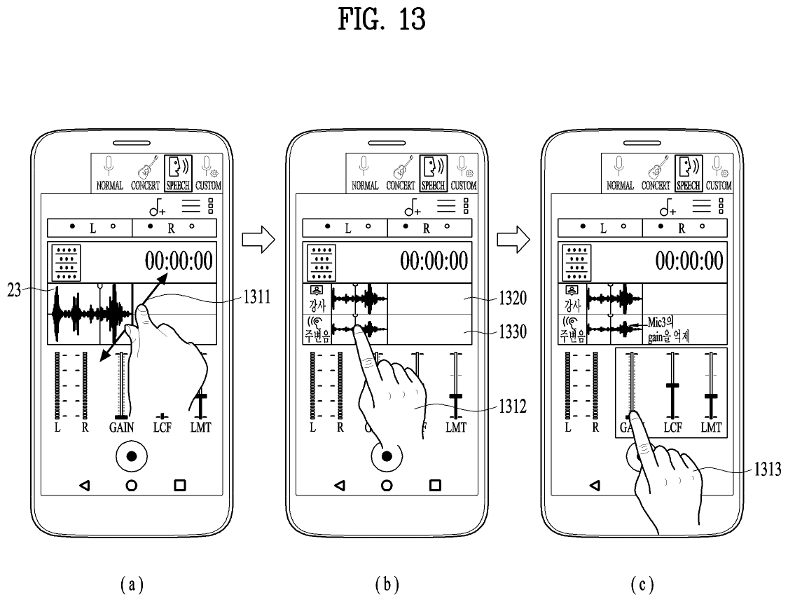

FIG. 13 is a diagram showing another example of recognizing a recording situation in a mobile terminal according to one embodiment of the present invention.

Particularly, the embodiment of FIG. 13 relates to a case that an input signal applied to a waveform region 23 is sensed while a speech preset is provided according to the recognition of a current situation before starting an audio recording. The contents redundant with those of the embodiment of FIG. 11 shall be omitted from the description of the embodiment of FIG. 13.

First of all, referring to FIG. 13 (a), a mobile terminal can output a waveform region 23 for a size of a sensed audio to a display unit while an audio is sensed before an audio recording. Here, if there are a plurality of sound sources of a sound sensed through a microphone, the waveform region 23 corresponds to a case of outputting a single waveform by synthesizing the sound sources together.

In doing so, the mobile terminal may sense a first input signal 1311 applied to the waveform 23. Here, the first input signal 1311 may correspond to a pinch-out touch input. In this case, as shown in FIG. 13 (b), the mobile terminal may separate the sensed audio into a first audio and a second audio and then output a waveform of each of the first audio and the second audio separately. Regarding the embodiment of FIG. 13, since a speech is in progress, the mobile terminal can separate a waveform into a lecturer and a bystander (or, audience).

Regarding this, a user may attempt to record an audio of the lecturer more efficiently rather than an audio of the bystander in a state that a speech is in progress. Namely, as shown in FIG. 13 (b), the mobile terminal may sense a second input signal 1312 applied to a bystander waveform 1330. For example, the second input signal 1312 may correspond to a single tap touch input.

In this case, the mobile terminal may enter an editing mode for the bystander waveform. Particularly, as shown in FIG. 13 (c), the mobile terminal can control values of a gain parameter, an LCF parameter and a limiter parameter through a third input signal 1313. For example, through the third input signal 1313, the mobile terminal can control the value of the gain parameter to be reduced into the smallest. If so, as a gain value of a surrounding sound is lowered, the user may be able to record a lecturer's audio effectively.

Although the embodiment of FIG. 13 relates to a case of configuring an audio preset based on a sound sensed before starting an audio recording, it may be also applicable to a case that an audio recording is in progress.

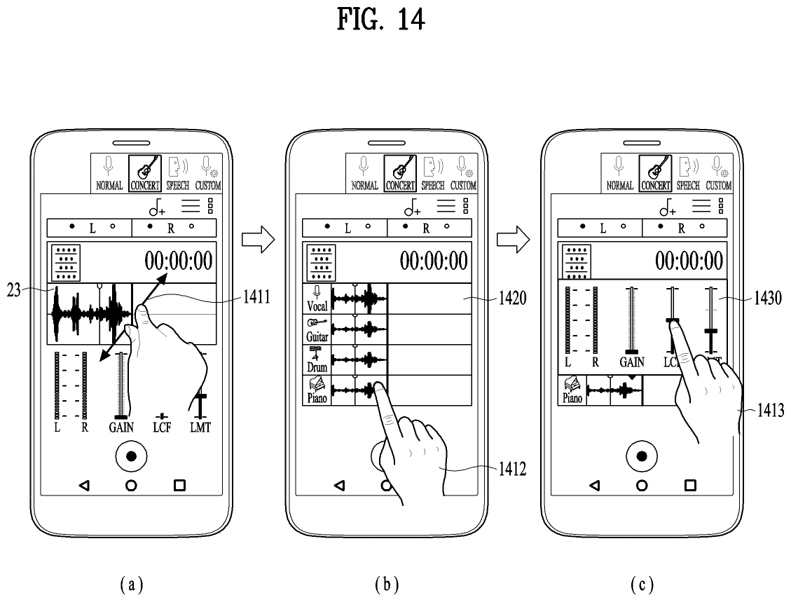

FIG. 14 is a diagram showing another example of recognizing a recording situation in a mobile terminal according to one embodiment of the present invention.

Particularly, the embodiment of FIG. 14 relates to a case of controlling a recording by separating a plurality of sound sources in the course of sensing an audio before starting an audio recording. And, the embodiment of FIG. 14 assumes a state that a mobile terminal recognizes a concert situation and then outputs a concert preset. The contents redundant with those of the embodiment of FIG. 11 shall be omitted from the description of the embodiment of FIG. 14.

Referring to FIG. 14 (a), a mobile terminal can output a concert preset to a display unit. A user may intend to adjust or set an audio sound, which is generated from a concert, in advance before starting an audio recording. In this case, the mobile terminal may sense a first input signal 1411 applied to a waveform region 23. For example, the first input signal 1411 may correspond to a pinch-out touch input or one of various inputs such as a double touch, a long touch and the like.

In response to the first input signal 1411, as shown in FIG. 14 (b), the mobile terminal may output a waveform for each of different sound sources. For example, the mobile terminal can extract a vocal sound source, a guitar sound source, a drum sound source and a keyboard sound source from a sound sensed from a concert. Moreover, as shown in FIG. 14 (b), the mobile terminal may control the waveform region 23 to be outputted in a manner of being divided into vocal, guitar, drum and keyboard.

In some implementations, a user of the mobile terminal may intend to change some setting values of the resource sound sources. In this case, it is able to sense a second input signal 1412 applied to a waveform region 1420 outputted per sound source of the mobile terminal. For example, the second input signal corresponds to a single touch input, by which the present invention is non-limited. In the embodiment of FIG. 14 (b), the mobile terminal can sense a second input signal 1412 applied to a keyboard waveform region 1420.

In this case, as shown in FIG. 14 (c), the mobile terminal can output a parameter control popup 1430 of a keyboard sound source corresponding to the second input signal 1412. Moreover, in response to a third input signal 1413 applied to the parameter control popup 1430, the mobile terminal can set the respective parameter values in detail. Meanwhile, if sensing an input signal (not shown) applied to a region to which the parameter control popup 1430 is not outputted [not shown in FIG. 14], the mobile terminal can remove the parameter control popup 1430.

In some implementations, according to the present embodiment, it is not necessary for every input signal to be sensed. And, it is possible to individually operate in a mobile terminal in response to each input signal. Moreover, if a pinch-in touch input applied to the waveform region 23 is sensed in the embodiment of FIG. 14, a single waveform generated from synthesizing the respective sound sources may be outputted. In this case, in response to an input signal applied to a parameter region, it is possible to control a parameter value for a sound generated from synthesizing a plurality of sound sources together.

Although the embodiment of FIG. 14 relates to a case of setting an audio preset based on a sound sensed before starting an audio recording, it may be applicable to a case that an audio recording is in progress.

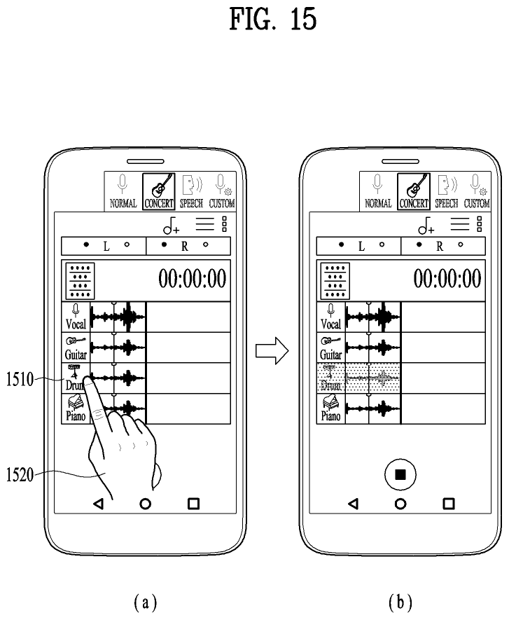

FIG. 15 is a diagram showing another example of recognizing a recording situation in a mobile terminal according to one embodiment of the present invention.

Particularly, the embodiment of FIG. 15 relates to a case of controlling a recording condition by separating a plurality of sound sources individually in case of sensing an audio before starting an audio recording.

The embodiment of FIG. 15 assumes that in a state that a mobile terminal recognizes a concert situation and then outputs an interface of a concert preset to a display unit, the mobile terminal outputs a waveform per sound source in response to a pinch-out touch input sensed from a user. The contents redundant with those of the embodiment of FIG. 14 shall be omitted from the description of the embodiment of FIG. 15.

In a state that a waveform per sound source is outputted in a mobile terminal, a user may intend to deactivate ‘sensing a prescribed sound source’. Regarding this, the mobile terminal may sense an input signal applied to an icon indicating a sound source. For example, the input signal may correspond to a single touch input to the icon or the like. In the embodiment of FIG. 15, the mobile terminal can sense an input signal applied to a drum icon 1510.

In this case, the mobile terminal may deactivate a sensing of an input signal sensed sound source or control the input signal sensed sound source to be switched to a mute state. Moreover, as shown in FIG. 15 (b), the mobile terminal can indicate a deactivated state in a manner that the graphic effect of the drum icon and the drum waveform is differentiated from that of other sound sources. For example, the graphic effect of the drum icon and waveform may correspond to a blurring or dimming effect.

In case of the embodiment of FIG. 15, as a size of a waveform region increases, a parameter region is not shown. In this case, in order for a user to adjust a parameter value per sound source, an input signal is applied to each sound source so as to enable a control in form of a popup like the former embodiment of FIG. 14. Moreover, in order for a user to adjust a total parameter value in a state that sound sources are synthesized together, in case of synthesizing waveforms into one by applying a pinch-in touch input, a parameter region may reappear on a bottom end.

In some implementations, not shown in FIG. 15, if an input signal applied to a drum icon is sensed in a deactivated state, a mobile terminal can re-activate a sound source of a drum. Moreover, although the embodiment of FIG. 15 relates to a case of setting an audio preset based on a sound sensed before starting an audio recording, it may be applicable to a case that an audio recording is in progress.

Providing Audio Preset by Considering Additional Information As Well As Sound Information

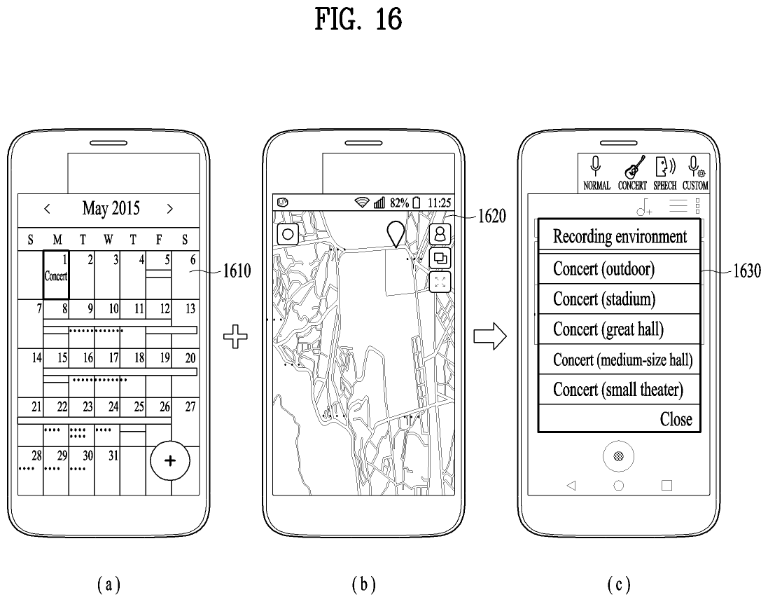

FIG. 16 is a diagram showing one example of recognizing a recording situation through additional information as well as sound information sensed through a microphone in a mobile terminal according to one embodiment of the present invention.

Particularly, the embodiment of FIG. 16 shows a method of providing an optimal audio preset by additionally considering calendar (schedule) information and place information as well as sound information through a microphone in case of launching an audio recording application.

Referring to FIG. 16 (a), a mobile terminal may extract or sense schedule information 1610 on ‘concert’ stored through a calendar application. Here, the calendar application may include a 3^{rd} party application as well as a calendar application basically provided by the mobile terminal. Moreover, referring to FIG. 16 (b), the mobile terminal can sense a current location information 1620 of the mobile terminal.

Moreover, in case of running an audio recording application, the mobile terminal can extract current schedule information from the calendar application. In the embodiment of FIG. 16, a timing of launching an audio recording application of the mobile terminal is assumed as similar to the ‘concert’ schedule recorded in the calendar application. Moreover, if the audio recording application is launched, the mobile terminal can extract a current location information through a location information sensing unit such as a GPS and the like. In the embodiment of FIG. 16, a place at which the audio recording application of the mobile terminal is assumed as a concert place.

In this case, as shown in FIG. 16 (c), the mobile terminal can control a concert preset to be outputted to a display unit. In doing so, the mobile terminal may output a place popup 1630 as a subcategory for a concert. Here, the place popup corresponds to a subcategory of a concert and may include various options of places at which a concert is held.

In some implementations, although the mobile terminal is described as extracting both schedule information and place information and then using them in determining a sound set, it may be able to additionally use the schedule information or the place information only.

Providing Additional Control Preset As Well As Audio Preset

FIG. 17 is a diagram showing one example of providing an audio preset and an additional control preset in case of launching an audio recording application in a mobile terminal according to one embodiment of the present invention.

Particularly, the embodiment of FIG. 17 shows a method of providing an optimal audio preset by additionally considering motion information of a mobile terminal as well as sound information sensed through a microphone in case of launching an audio recording application.

In the embodiment of FIG. 17, if an audio recording application is launched, a mobile terminal is assumed as currently providing a classic preset based on place information, sound information and the like. And, the mobile terminal may start an audio recording in response to a control command.

In some implementations, the mobile terminal may sense sound information through a microphone and also sense motion information of the mobile terminal additionally. Based on the additionally sensed motion information, the mobile terminal may provide an additional control preset as well as an audio preset. In case of the embodiment of FIG. 17, since a classical concert is being performed, it may correspond to a state that there is almost no motion of the mobile terminal. Therefore, the mobile terminal may provide a function of additionally eliminating noise of a background using an additional control preset 1710. Besides, the mobile terminal may provide a distortion prevention function due to a sound level as well as the noise elimination using a classic preset.

FIG. 18 is a diagram showing another example of providing an audio preset and an additional control preset in case of launching an audio recording application in a mobile terminal according to one embodiment of the present invention.

Particularly, the embodiment of FIG. 18 shows a method of providing an optimal audio preset by additionally considering motion information of a mobile terminal as well as sound information sensed through a microphone in case of launching an audio recording application.

In the embodiment of FIG. 18, if an audio recording application is launched, a mobile terminal is assumed as currently providing a concert preset based on place information, sound information, schedule information and the like. In this case, the mobile terminal may start an audio recording in response to a control command.

Meanwhile, the mobile terminal can additionally sense motion information of the mobile terminal while sensing sound information. And, the mobile terminal may provide an additional control preset as well as an audio preset based on the additionally sensed motion information. Unlike the embodiment of FIG. 17, in case of the embodiment of FIG. 18, a user holding the mobile terminal in user's hand may wave user's arms right and left during the concert. In doing so, the mobile terminal can sense that motion is generated right and left in a predetermined pattern through at least one of a gyro sensor and an acceleration sensor.

Therefore, the mobile terminal can provide a microphone channel selection function and a function of additionally eliminating noise using an additional control preset 1810. Here, the microphone channel selection function may correspond to a function of uniformly recording a concert sound according to a motion using a directional microphone. For example, in the embodiment of FIG. 17, when the microphone channel selection function is applied, if the mobile terminal inclines to the left, a gain value of a right microphone can be controlled to be raised. If the mobile terminal inclines to the right, a gain value of a left microphone can be controlled to be raised.

Although it is not shown in FIG. 17 and FIG. 18, the mobile terminal may sense a violent motion instead of a predetermined pattern while providing a concert preset. In this case, as an additional control preset, it is able to provide a mono recording function, a noise elimination function, a gain control function and the like.

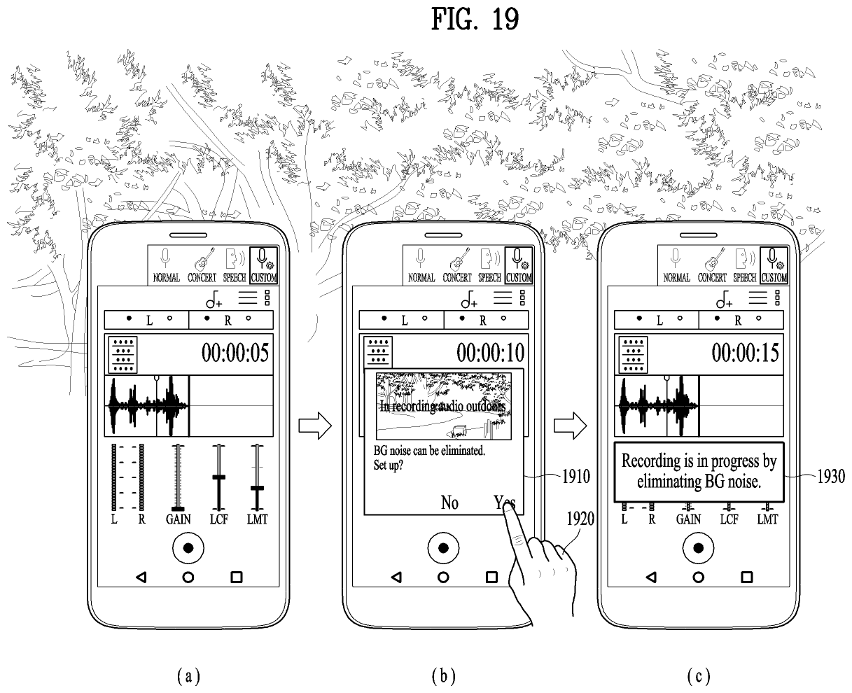

FIG. 19 is a diagram showing another example of providing an audio preset and an additional control preset in case of launching an audio recording application in a mobile terminal according to one embodiment of the present invention.

Particularly, the embodiment of FIG. 19 shows a method of providing an optimal audio preset if a background sound is sensed as well as a main sound sensed through a microphone.

Referring to FIG. 19 (a), in a state that an audio recording is started by launching an audio recording application, a mobile terminal can sense a background sound additionally. In the embodiment of FIG. 19, the background sound may correspond to ambient noise such as cicada sound and the like outdoors. Moreover, the background sound may correspond to noise such as café music and the like indoors [not shown in FIG. 19].

In this case, the mobile terminal can output an additional preset popup 1910. For example, the additional control preset popup 1910 may correspond to a menu for providing a preset additionally as well as an audio preset provided by the audio recording application. In the embodiment of FIG. 19, the additional control preset popup 1910 corresponds to a popup for eliminating background noise in case of an outdoor recording.

Moreover, the mobile terminal can sense an input signal 1920 applied to the additional preset popup 1910. Here, the input signal 1920 may correspond to an input for eliminating background noise in case of an outdoor recording. For example, the input signal 1920 may correspond to a single touch input. Moreover, the mobile terminal can recommend various configurations as well as the preset for eliminating the background noise.

In this case, the mobile terminal can continue to perform the audio recording by additionally applying an additional control preset to an audio preset. Moreover, as shown in FIG. 19 (c), the mobile terminal can output an indicator 1930 indicating that a background noise elimination preset is operating.

Meanwhile, although FIG. 19 is described as applying an additional control preset while a recording is in progress in an audio application, it may be possible to perform a recording by applying an additional preset before starting the recording.

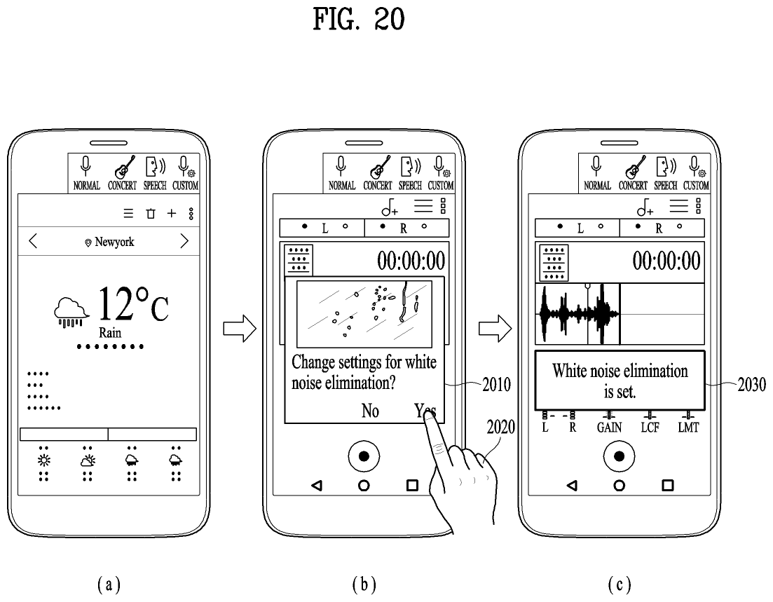

FIG. 20 is a diagram showing another example of providing an audio preset and an additional control preset in case of launching an audio recording application in a mobile terminal according to one embodiment of the present invention.

Particularly, the embodiment of FIG. 20 shows a method of providing an optimal audio preset in case of additionally sensing weather information as well as a main sound sensed through a microphone. The contents redundant with those of the embodiment of FIG. 19 shall be omitted from the description of the embodiment of FIG. 20.

If an audio recording application is launched, a mobile terminal can sense current weather information. For example, as shown in FIG. 20 (a), the mobile terminal can obtain weather information of an area, in which the mobile terminal is located, through online information such as a weather application. For example, although not shown in FIG. 20, the mobile terminal may determine weather information through sound information (sensed by a microphone) such as rain sound, wind sound and the like.

In this case, the mobile terminal can output an additional preset popup 2010. For example, the additional preset popup 2010 may correspond to a menu for providing a preset additionally as well as an audio preset. In the embodiment of FIG. 20 (b), the additional preset popup 2010 corresponds to a popup for providing a function of eliminating white noise such as rain sound.

Moreover, the mobile terminal can sense an input signal 2020 applied to the additional preset popup 2010. Here, the input signal 2020 may correspond to an input for eliminating white noise generated during an audio recording. In this case, in case of starting an audio recording, the mobile terminal can perform the recording by eliminating white noise. Moreover, as shown in FIG. 20 (c), the mobile terminal can output an indicator 2030 indicating that a white noise elimination function is set.

Meanwhile, although the embodiment of FIG. 20 relates to a case that a white noise elimination function is additionally applied in a step before starting an audio recording, it may be possible to provide a popup for white noise elimination during the audio recording in progress.

Temporary Recording for Predetermined Time Before Audio Recording

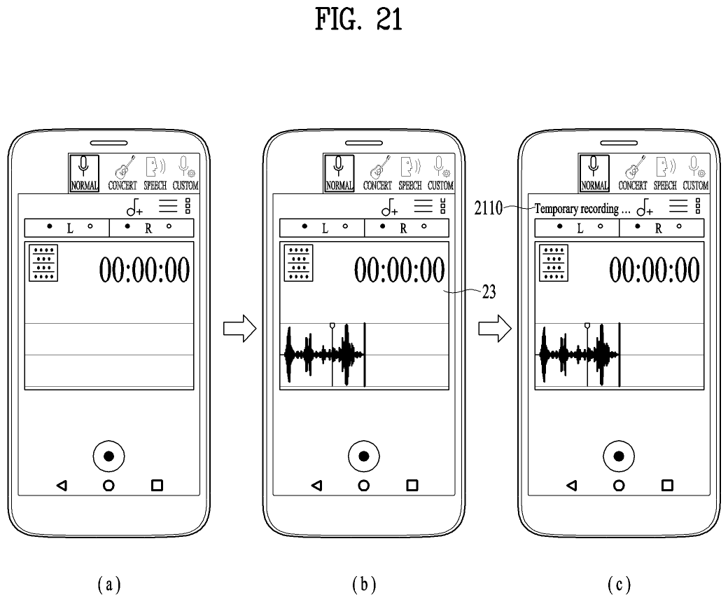

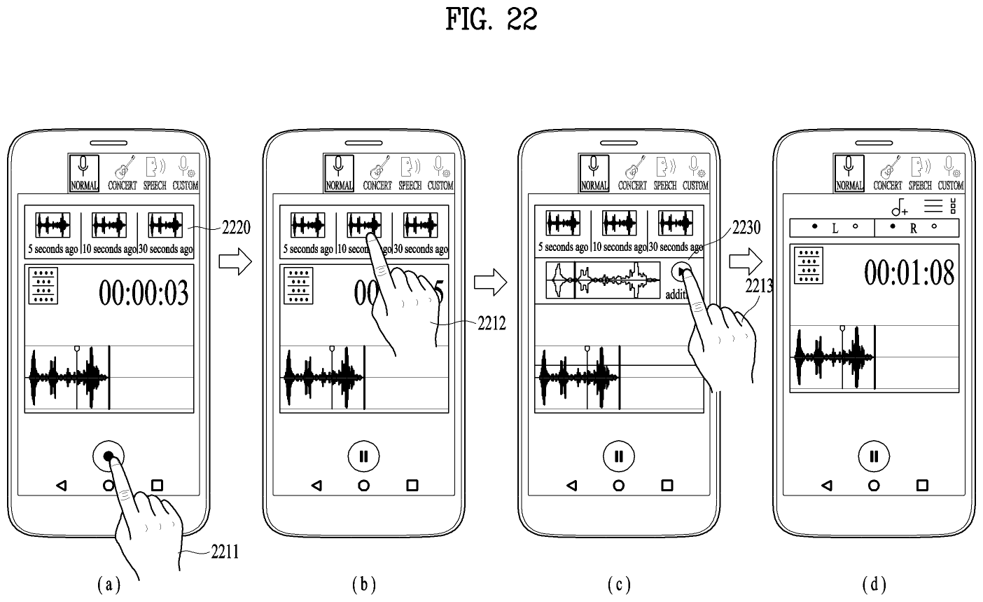

As described above, if an audio recording application is launched, a plurality of microphones provided to a mobile terminal are activated to sense sounds. Moreover, for user's convenience, even if there is no command for an audio recording, a mobile terminal may record a sound for a preset time in advance. A method of providing a temporary recording function before an audio recording shall be described with reference to FIG. 21 and FIG. 22 as follows.

FIG. 21 is a diagram showing one example of performing a temporary recording automatically before starting an audio recording in a mobile terminal according to one embodiment of the present invention.

First of all, referring to FIG. 21 (a), a mobile terminal may be in an audio recording standby state after launching an audio recording application. If the audio recording application is launched, as described in FIG. 8, an interface of a basic preset can be outputted to a display unit.

Moreover, if the audio recording application is launched, as described in FIG. 8, as a microphone is activated, the mobile terminal can sense a surrounding sound. In doing so, if a size of a sound sensed through the microphone is equal to or smaller than a preset sound size, the mobile terminal may not perform a temporary recording. For example, as shown in FIG. 21 (a), if a sound size is small, a waveform is not outputted and the mobile terminal may not perform the temporary recording.

Yet, if a size of a sound sensed through the microphone is greater than the preset sound size, the mobile terminal may start the temporary recording. As shown in FIG. 21 (b), if a sound size exceeds a predetermined range, a waveform 23 is outputted and the mobile terminal can start the temporary recording. For example, if a specific person's voice is sensed over a predetermined volume, the mobile terminal can start the temporary recording. Moreover, as shown in FIG. 21 (c), the mobile terminal can output an indicator 2110, which indicates that the temporary recording is in progress, to a display unit. Through this, a user can recognize that the temporary recording is in progress.

In some implementations, although not shown in FIG. 21, if an audio different from an audio currently sensed in a temporary recording is sensed, the mobile terminal may stop the temporary recording and then start a temporary recording using a different file. And, the mobile terminal may temporarily save the temporary recorded file to a memory. This shall be described with reference to FIG. 22.

FIG. 22 is a diagram showing one example of performing a temporary recording automatically before starting an audio recording in a mobile terminal according to one embodiment of the present invention.

Particularly, the embodiment of FIG. 22 shows a method for a user to add a necessary file in the temporary recording file described in FIG. 21 to a main recording file.

Referring to FIG. 22 (a), a mobile terminal can sense a first input signal 2211 for an audio recording. In this case, the mobile terminal can perform an actual audio recording. If the actual audio recording is started, the mobile terminal can output a selection menu 2220 of a temporary recording file performed before the actual audio recording. For example, as shown in FIG. 22 (a), the selection menu 2220 of the temporary recording file corresponds to a menu for selecting a necessary timing with reference to a timing of ending a recording of the temporary recording file.

Subsequently, referring to FIG. 22 (b), the mobile terminal can sense a second input signal 2212 applied to a menu for selecting ‘10 seconds ago’ in the selection menu 2220. In this case, as shown in FIG. 22 (c), the mobile terminal can output a menu 2230 for providing a preview of the selected menu. For example, if an earphone is connected to the mobile terminal, a user can monitor the temporary recording file even during an audio recording in progress. Moreover, referring to FIG. 22 (d), if sensing a third input signal 2213 applied to a menu adding button, the mobile terminal can add the temporary recording file in front of a currently recorded file. If the audio recording in progress is completed in response to the third input signal 2213, the mobile terminal can add and save the temporary recording file to the memory.

Providing Audio Preset During Video Shooting

A mobile terminal can provide the aforementioned high-quality audio recording function during a video shooting. In this case, the mobile terminal can provide various audio presets even during the video shooting. A method of providing an audio preset during a video shooting shall be described with reference to FIGS. 23 to 26 as follows.

FIG. 23 is a diagram showing one example of providing an audio preset in the course of a video shooting in a mobile terminal according to one embodiment of the present invention.

If a video application is launched, a mobile terminal can output a video preview 50 to a display unit. Regarding this, the mobile terminal can output an audio preset menu 55 as well as the video preview 50. Moreover, referring to FIG. 23 (a), the mobile terminal can sense a firs input signal 2311 applied to the audio preset menu 55. In the embodiment of FIG. 23, the audio preset menu 55 can be represented as audio. Here, the first input signal 2311 corresponds to a signal for setting the audio preset menu 55. If an input signal applied to the audio preset menu 55 is not sensed in a state that the video application is running, the mobile terminal can shoot a video in a state that an audio preset is not provided.

Referring to FIG. 23 (b), in response to the first input signal 2311, the mobile terminal can output an audio preset popup 2320. Here, the audio preset popup 2320 may include a waveform, a gain parameter, an LCF parameter and a limiter parameter identical to show provided by an audio recording application. Through this, a user can obtain a high-quality audio file even during a video shooting.

Moreover, while the video application is running, if an audio preset is configured, the mobile terminal can display the configured audio preset on a first display region 10. Although the embodiment of FIG. 23 shows a case that the audio preset is configured manually by a user, it is possible to provide a recommended audio preset automatically in the video application like the audio recording application in FIG. 11. This shall be described with reference to FIG. 24 as follows.

FIG. 24 is a diagram showing another example of providing an audio preset in the course of a video shooting in a mobile terminal according to one embodiment of the present invention.

Particularly, the embodiment of FIG. 24 shows a method of providing an audio preset by sensing a sound through a microphone even before a video shooting in case of launching a video application. The contents redundant with those of the embodiment of FIG. 23 shall be omitted from the description of the embodiment of FIG. 24.

Referring to FIG. 24 (a), if a video application is launched, a mobile terminal can output a video preview 50 to a display view. And, the mobile terminal can sense a sound sensed from surroundings through a microphone while outputting the video preview 50. Moreover, the mobile terminal can determine an audio preset based on the sensed sound. Furthermore, the mobile terminal may determine an optimized audio preset through a subject sensed through a camera. In some implementations, as described with reference to FIG. 16 and FIG. 176, the mobile terminal may determine an audio preset based on schedule or place information.

In this case, the mobile terminal can output an audio preset popup 2410 in a manner that the audio preset popup 2410 overlays the video preview 50. For example, in the embodiment of FIG. 24, the mobile terminal is in a standby state for shooting a live concert and can output a concert preset popup. And, the mobile terminal can sense a first input signal 2421 applied to the audio preset popup 2410. Here, the first input signal 2421 is an input to ‘Yes’ for being provided with an audio preset and may correspond to a single touch input.

Meanwhile, although not shown in FIG. 24, if an input to ‘No’ of the audio preset popup 2410 is sensed, the mobile terminal can record an audio file of a video in normal mode without adding a setting of an audio preset. Moreover, although not shown in FIG. 24, if a flicking touch input to the audio preset popup 2410 is sensed, as described in FIG. 11, the mobile terminal may output a different audio preset popup.

In response to the first input signal 2421, the mobile terminal can output a waveform popup 2430. In this case, as shown in FIG. 24 (b), the mobile terminal can output a plurality of waveforms 2430 according to types of sound sources. Yet, unlike FIG. 24 (b), the mobile terminal may output a single waveform generated from synthesizing a plurality of sound sources together.

The mobile terminal can sense a second input signal 2422 applied to one of a plurality of the waveform 2430. In this case, as shown in FIG. 24 (c), the mobile terminal can output a parameter popup 2440 for a sound source of the waveform from which the second input signal 2422 is sensed. And, the mobile terminal can configure a sound quality through a third input signal 2423 applied to the parameter popup 2440.

Subsequently, the mobile terminal can sense a fourth input signal 2424 applied to a video recording menu. In this case, the mobile terminal can perform a video recording based on the configured audio preset. Moreover, as shown in FIG. 24 (d), the mobile terminal may output information 2450 on the audio preset during the video recording. For example, as shown in FIG. 24 (d), the information 2450 on the audio preset may correspond to waveform information.

In some implementations, although the mobile terminal is described as outputting the waveform popup 2430 in response to the first input signal 2421 in the embodiment of FIG. 24, it may be possible to output an interface of an audio preset like FIG. 11.

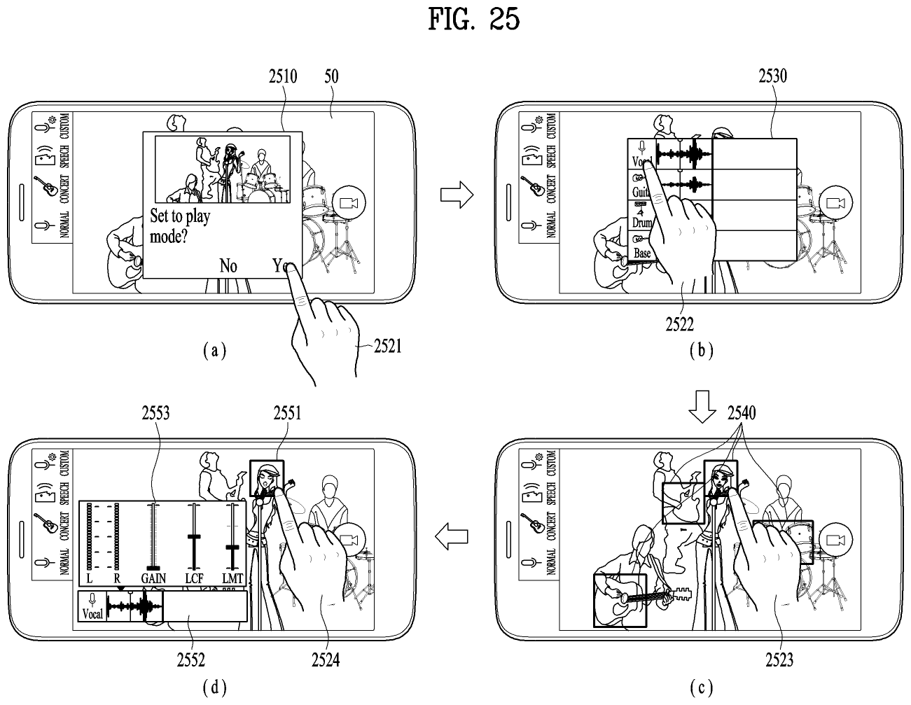

FIG. 25 is a diagram showing another example of providing an audio preset in the course of a video shooting in a mobile terminal according to one embodiment of the present invention.

Particularly, the embodiment of FIG. 25 shows a method of sensing a sound per object outputted to a preview in case of launching a video application. The contents redundant with those of the embodiment of FIG. 24 shall be omitted from the description of the embodiment of FIG. 25.

Referring to FIG. 25 (a), in case of launching a video application, a mobile terminal can output a video preview 50 to a display view. Based on a sensed sound, the mobile terminal can output an audio preset popup 2510. For example, in the embodiment of FIG. 25, an audio preset may correspond to a band preset. The mobile terminal can sense a first input signal 2521 applied to the audio preset popup 2510. Here, the first input signal 2521 is an input for being provided with an audio preset during a video shooting and may correspond to a single touch input.

In response to the first input signal 2521, the mobile terminal can output a waveform popup 2520. In doing so, as shown in FIG. 24 (b), the mobile terminal can output a waveform per sound source of a sensed sound. Instead, in response to the first input signal 2521, the mobile terminal may output a single waveform generated from synthesizing a plurality of sensed sound sources together.

The mobile terminal can sense a second input signal 2522 applied to one of a plurality of the waveforms. Here, the second input single 2522 corresponds to a signal for mapping an object sensed by a camera and a sound source together. In this case, as shown in FIG. 25 (c), a focus indicator 2540 may be outputted. For example the focus indicator 2540 corresponds to marking an object corresponding to a sound source. In the embodiment of FIG. 25 (c), the focus indicator 2540 can be outputted to a location of each of a face of a vocalist, an electric guitar, a base guitar, a drum, a keyboard and the like.

The mobile terminal can sense a third input signal 2523 applied to a face of a vocalist in the focus indicator 2540. In this case, the mobile terminal can map a waveform of the vocal and a face of the vocal to each other. A user repeats the steps of the second and third input signals, thereby mapping each wave form and an object corresponding to a sound source to each other [not shown in FIG. 25].

Subsequently, after completing the mapping between the waveform and the sound source, the mobile terminal can sense a fourth input signal 2524 applied to a vocal object 2551 on the video preview 50. In this case, as shown in FIG. 25 (d), the mobile terminal can output a waveform 2552 corresponding to the vocal object 2551. In doing so, if an additional input signal (not shown) applied to the waveform 2552 is sensed, the mobile terminal can output a parameter popup 2553 for the vocal object 2551.

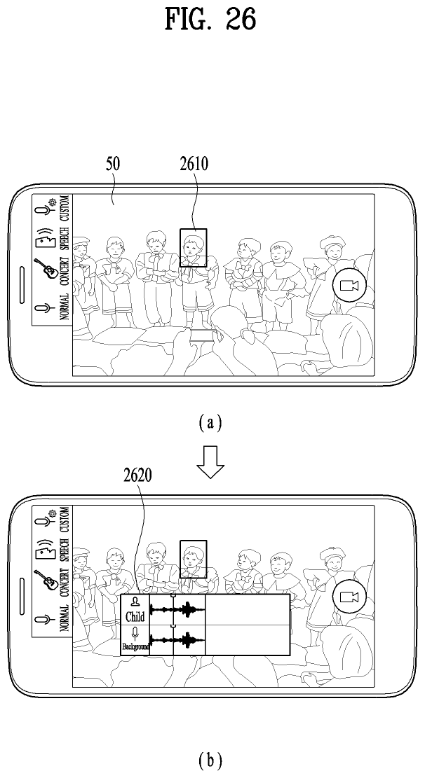

FIG. 26 is a diagram showing another example of providing an audio preset in the course of a video shooting in a mobile terminal according to one embodiment of the present invention.

Particularly, the embodiment of FIG. 26 shows a method of providing an optimal audio preset in case of recognizing a specific character on a camera preview when a video application is launched. The contents redundant with those of the embodiment of FIG. 24 shall be omitted from the description of the embodiment of FIG. 26.

Referring to FIG. 26 (a), in case of launching a video application, a mobile terminal can output a video preview 50 to a display unit. In doing so, the mobile terminal can perform face recognition through the camera preview 50. As a result of the face recognition, if a sensed subject matches a preset character, the mobile terminal can output a matching indicator 26120 to the camera preview 50.

Referring to FIG. 26 (b), if recognizing the preset character, the mobile terminal can output a waveform 2620 to a location adjacent to the preset character. In this case, the outputted waveform 2620 may be configured in a manner that a sound source of a preset character and the rest of sound sources in the sensed sound are outputted by being separated from each other. Regarding this, assume that the sound source for the preset character and a face of the preset character are already mapped and stored in a memory. Moreover, in case of the embodiment of FIG. 26, if a face of a child is recognized, it is able to separate and extract a voice of the child separately, which may correspond to a kids mode.

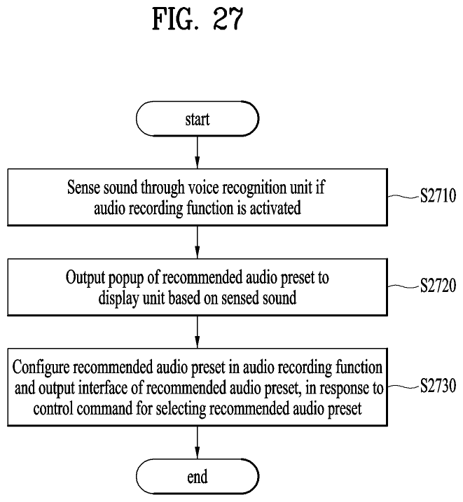

FIG. 27 is a flowchart showing a method of controlling a mobile terminal according to one embodiment of the present invention.

First of all, if an audio recording function is activated, a mobile terminal can sense a sound through a voice recognition unit [S2710]. Here, the audio recording function activated case may include at least one of the audio recording application launched cases described in FIGS. 7 to 22 and the video recording application launched cases described in FIGS. 23 to 26. If the audio recording function is activated, the mobile terminal can activate at least some of a plurality of microphones provided to the mobile terminal.

Subsequently, based on the sensed sound, the mobile terminal can output a popup of a recommended audio preset among a plurality of audio presets to a display unit [S2720]. Particularly, based on the sensed sound, the mobile terminal can output a recommended audio preset popup to a second display region. Regarding this, as described in FIG. 16, the mobile terminal can output the recommended audio preset popup to the display unit by considering at least one of schedule information and place information in addition to the sensed sound.

Subsequently, in response to a control command for selecting a recommended audio preset, the mobile terminal can configure a recommended audio preset in the audio recording function [S2730]. Regarding this, as described in FIGS. 7 to 22, if the audio recording function is an audio recording application, the mobile terminal can output an interface corresponding to the recommended audio preset to the display unit in response to the control command. Moreover, as described in FIGS. 23 to 26, if an audio recording function is included in a video recording application, the mobile terminal does not output an interface corresponding to the recommended audio preset but is able to output a camera preview, in response to the control command.

Moreover, as described in FIGS. 17 to 20, in a state that the recommended audio preset is configured, the mobile terminal may provide an additional audio preset based on at least one of weather information, location information, motion information and background sound information.

Moreover, although the drawings are separately described for clarity of description, it is possible to design and implement a new embodiment by merging embodiments described and illustrated in the respective drawings.

Furthermore, a mobile terminal and controlling method thereof may be configured in a manner of selectively combining the respective embodiments entirely or in part so that various modifications can be achieved, instead of limitedly applying the configurations and methods of the above-described embodiments.

The present invention mentioned in the foregoing description can be implemented in a program recorded medium as computer-readable codes. The computer-readable media may include all kinds of recording devices in which data readable by a computer system are stored. The computer-readable media may include HDD (Hard Disk Drive), SSD (Solid State Disk), SDD (Silicon Disk Drive), ROM, RAM, CD-ROM, magnetic tapes, floppy discs, optical data storage devices, and the like for example and also include carrier-wave type implementations (e.g., transmission via Internet). Further, the computer may include the controller 180 of the terminal. The foregoing embodiments are merely exemplary and are not to be considered as limiting the present disclosure. The present teachings can be readily applied to other types of methods and apparatuses. Thus, it is intended that the present invention covers the modifications and variations of this invention that come within the scope of the appended claims and their equivalents.

### INDUSTRIAL APPLICABILITY

The present invention has industrial applicability in a mobile terminal and is applicable repeatedly.

What is claimed is:

1. A mobile terminal, comprising:
a display unit;
a voice recognition unit; and
a controller configured to:
if an audio recording function is activated, sense a sound through the voice recognition unit,
output a popup of a recommended audio preset determined on the basis of the sensed sound among a plurality of audio presets to the display unit, and
set the recommended audio preset for the audio recording function in response to a control command for selecting the recommended audio preset popup.

2. The mobile terminal of claim 1, wherein the voice recognition unit includes a plurality of microphones provided to different locations of the mobile terminal and
wherein if the audio recording function is activated, the controller is further configured to:
activate at least one portion of a plurality of the microphones and
sense the sound through the activated at least one portion of a plurality of the microphones before starting the audio recording.

3. The mobile terminal of claim 2, wherein the controller is further configured to:
perform a temporary recording for a prescribed time before starting the audio recording and
if the audio recording is started, output a menu for adding at least one portion of audio data of the temporary recording to an actually recorded audio data.

4. The mobile terminal of claim 1, further comprising:
a location sensing unit; and
a memory,
wherein the controller is further configured to determine the recommended audio preset based on at least one of schedule information stored in the memory and location information of the mobile terminal sensed through the location sensing unit and the sensed sound.

5. The mobile terminal of claim 1, wherein the display unit includes a first display region and a second display region located on one side of the first display region.

6. The mobile terminal of claim 5, wherein the controller is further configured to control an interface corresponding to the recommended audio preset to be outputted to the second display region in response to the control command for selecting the recommended audio preset.

7. The mobile terminal of claim 6, wherein the interface corresponding to the recommended audio preset includes a waveform region and
wherein if a plurality of sound sources are extracted from the sensed sound, the controller is further configured to control the waveform region to be outputted in a manner of being divided into a waveform region of each of a plurality of the sound sources in response to a control command for the waveform region.

8. The mobile terminal of claim 5, wherein if the audio recording function is activated, the controller is further configured to:
output icons corresponding to a plurality of the audio presets to the first display region and
highlight an icon corresponding to the recommended audio preset among the icons in response to a control command for selecting the recommended audio preset.

9. The mobile terminal of claim 5, wherein if a situation change is sensed in a state that the recommended audio preset is set for the audio recording function, the controller is further configured to output a situation change indicator to the first display region.

10. The mobile terminal of claim 1, wherein the audio recording function operates in at least one of an audio recording application and a video recording application.

11. A method of controlling a mobile terminal, comprising:
if an audio recording function is activated, sensing a sound through a microphone;
outputting a popup of a recommended audio preset determined on the basis of the sensed sound among a plurality of audio presets to a display unit; and
setting the recommended audio preset for the audio recording function in response to a control command for selecting the recommended audio preset popup.

12. The method of claim 11, further comprising:
if the audio recording function is activated, activating at least one portion of a plurality of microphones; and
sensing the sound through the activated at least one portion of a plurality of the microphones before starting the audio recording.

13. The method of claim 12, further comprising:
performing a temporary recording for a prescribed time before starting the audio recording; and
if the audio recording is started, outputting a menu for adding at least one portion of audio data of the temporary recording to an actually recorded audio data.

14. The method of claim 11, the setting the recommended audio preset, further comprising determining the recommended audio preset based on at least one of schedule information stored in the memory and location information of the mobile terminal sensed through a location sensing unit and the sensed sound.

15. The method of claim 11, wherein the display unit includes a first display region and a second display region located on one side of the first display region.

16. The method of claim 15, the setting the recommended audio preset, further comprising controlling an interface corresponding to the recommended audio preset to be outputted to the second display region in response to the control command for selecting the recommended audio preset.

17. The method of claim 16, wherein the interface corresponding to the recommended audio preset includes a waveform region and wherein if a plurality of sound sources are extracted from the sensed sound, the setting the recommended audio preset further comprises controlling the waveform region to be outputted in a manner of being divided into a waveform region of each of a plurality of the sound sources in response to a control command for the waveform region.

18. The method of claim 15, further comprising:
if the audio recording function is activated, outputting icons corresponding to a plurality of the audio presets to the first display region; and
highlighting an icon corresponding to the recommended audio preset among the icons in response to a control command for selecting the recommended audio preset.

19. The method of claim 15, further comprising: if a situation change is sensed in a state that the recommended audio preset is set for the audio recording function, outputting a situation change indicator to the first display region.

20. The method of claim 11, wherein the audio recording function operates in at least one of an audio recording application and a video recording application.
